(19) United States
(12) Patent Application Publication
(10) Pub. No.: US 2006/0287956 A1
(43) Pub. Date: Dec. 21, 2006

(54) System and method for time based digital content access

(76) Inventors: Akio Higashi, Takatsuki-shi (JP); Ryuichi Okamoto, Kadoma-shi (JP)

Correspondence Address: WENDEROTH, LIND & PONACK L.L.P., 2033 K. STREET, NW, SUITE 800, WASHINGTON, DC, 20006, US

(21) Appl. No.: 10/568,099

(22) PCT Filed: Sep. 29, 2004
(86) PCT No.: PCT/JP04/14667

§ 371 Date: Feb. 13, 2006

(30) Foreign Application Priority Data
Nov. 7, 2003 (JP) 2003-378574

(51) Int. Cl. G06Q 99/00

(52) U.S. Cl. 705/51

(57) ABSTRACT

A content reproduction control system comprising a server apparatus and a terminal apparatus that are connected via a communication path, wherein the server apparatus includes: based on time information attached to a content, a control information generation unit operable to generate control information for specifying a range for permitting or prohibiting a user's predetermined operation in the terminal apparatus; and a distribution unit that distributes the control information to the terminal apparatus, the terminal apparatus includes: a content use unit operable to use the content; a receiving unit operable to receive the control information; and a content use control unit operable to control reproduction of the content based on the received control information.

### TECHNICAL FIELD

The present invention relates to a system in which a server apparatus distributes digital contents such as video and music through communication and broadcast and in which the digital contents are used in a terminal apparatus by a user. It relates in particular to a system for controlling a special reproduction (a trick play) such as time skip and fast-forward for a specific part of the digital contents in the terminal apparatus according to an intention of a provider.

### BACKGROUND ART

In recent years, a content distribution service which is capable of distributing digital contents such as music, video and game (hereafter referred to as content) from a server apparatus to a terminal apparatus through communication such as Internet, digital broadcast, Cable Television (CATV), and of using the content in a terminal apparatus has developed for a practical use. A common system used for the content distribution uses a copyright protection technique for protecting a copyright of content in order to prevent an illegal use of the content by a malicious user. The copyright protection technique is, in specific, a technique of securely controlling use of content by a user such as reproducing the content or copying it to a recording media using encoding technique, identification technique and the like. Using the copyright protection technique allows a provider such as a content provider and a service provider to securely control the use of content in the terminal apparatus by a user.

By the way, a usage pattern with high usability by the user in a terminal apparatus having a large storage unit such as a Hard Disk Drive (HDD) has examined. The high usability includes temporally storing a distributed content to the terminal apparatus and viewing a content which the user wants to see at whenever the user wishes to. At an Association of Radio Industries and Businesses (ARIB) that is an organization of standardizing digital broadcast in Japan, a server-type broadcasting method is standardized as a digital broadcasting method using a large capacity storage function. As for the server-type broadcasting method, ARIB STD-B25 version 4.1 explains in detail.

However, in the terminal apparatus having such storage function, a situation that users do not watch a commercial message (CM) is caused by temporally storing a content including the CM into the terminal apparatus, skipping, fast forwarding and rewinding a CM part while watching by a time shift. Consequently, it is likely to cause demerits that a CM effect is weakened for the provider and the CM cost is lowered. As a technique resolving the problem, for example, a patent literature: a Japanese Laid-Open Patent Literature application no. 2002-209878, explains a system of controlling a CM skip in the terminal apparatus as an example of the content reproduction control system by embedding a CM skip prohibition signal or a CM skip prohibition reset signal before and after the CM part of the content in the server apparatus.

Accordingly, in the conventional content reproduction control system, it can prevent the use of content by a user contrary to the intention of the provider by embedding control information indicating that a special reproduction is prohibited in an area such as the CM part of the content and the like where the content provider wants to prohibit the use of the special reproduction.

However, the conventional content reproduction control system prevents a special reproduction of the CM part so that control information for controlling a CM viewing needs to be embedded into the content. In general, it is common that an encoder that digitally encodes the content does not have a function of identifying the CM part of the content or even a function of inserting information for the CM viewing control. Therefore, it is necessary to have a specialized encoder to generate a content which can control the CM viewing. Consequently, it causes an increase of costs on the provider.

Resolving these conventional problems, the present invention aims to provide a content reproduction control system capable of preventing the content use by the user contrary to the intention of the provider at low cost by securely realizing the use control of a specific part of the content such as CM part in the terminal apparatus without inserting control information to the content.

### DISCLOSURE OF INVENTION

In order to achieve the above-mentioned objective, the content reproduction control system according to the present invention comprises a server apparatus and a terminal apparatus that are connected to each other via a communication path, wherein the server apparatus includes: a control information generation unit operable to generate, based on time information attached to a content, control information which specifies a range for permitting and prohibiting a user's predetermined operation on a reproduction of the content performed in the terminal apparatus; and a distribution unit operable to distribute the control information to the terminal apparatus, and the terminal apparatus includes: a content use unit operable to use the content; a receiving unit operable to receive the control information; and a content use control unit operable to control the reproduction of the content based on the received control information, the reproduction being included in the use of the content performed by the content use unit.

The present configuration makes it possible to securely control a specific portion of the content without embedding special information into the content for the use control.

According to the present invention, the CM viewing by a user can be securely controlled using secure time information pre-existed in the content without embedding the control information for controlling the CM viewing in the content body. Therefore, the present invention can apply content generated using a general encoder and can reduce cost burdens on a provider. Furthermore, securely binding the content such as when the preexisted time information is encrypted in the content, the CM viewing by the user can be securely controlled using the time information.

Note that the present invention can be realized not only as a content reproduction control system but also as a server apparatus and a terminal apparatus that configures the content reproduction control system, a content reproduction control method having characteristic steps included in the server apparatus and the terminal apparatus, as well as a program that causes a computer to execute such steps. Here, it is needless to say that such program can be distributed via recording medium such as CD-ROM or via a transmission medium such as Internet.

As further information about technical background to this application, the disclosure of Japanese Patent Application No. 2003-378574 filed on Nov. 7, 2003 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a conceptual configuration of a content reproduction control system 1 as a whole according to the embodiment of the present invention.

FIG. 2 is a diagram showing a sketch of an encryption key scheme in a content distribution based on a server type broadcasting method type I.

FIG. 3 is a functional block diagram showing a detailed configuration of a right management server 101a shown in FIG. 1.

FIG. 4 is a diagram showing an example of a structure of a work key management table 400 in a key information DB 301.

FIG. 5 is a diagram showing an example of a structure of a key management table 500 in the key information DB 301.

FIG. 6 is a diagram showing an example of a structure of a user information management table 600 in a user information DB 302.

FIG. 7 is a diagram showing an example of a structure of a usage rule management table 700 in a usage rule DB 303.

FIG. 8 is a diagram showing an example of a structure of a content information management table 800 in a content information DB 304.

FIG. 9 is a diagram showing an example of a structure of a main license 900.

FIG. 10 is a diagram showing an example of a structure of a sublicense 1000.

FIG. 11 is a functional block diagram showing a detailed configuration of a content distribution server 101b shown in FIG. 1.

FIG. 12 is a diagram showing an example of a structure of a content attribute information management table 1200 in a content attribute information DB 1102.

FIG. 13 is a diagram showing a schema of a structure of a PES packet 1300.

FIG. 14 is a diagram showing a schema of a structure of a TS packet 1400.

FIG. 15 is a diagram showing a data structure of a control information tag block 1500.

FIG. 16 is a conceptual diagram showing a method of calculating a PTS1343a in the beginning of the content.

FIG. 17 is a diagram showing an example of reproduction control information (control information 1503) according to the embodiment of the present invention.

FIG. 18 is a diagram showing an example of structures of ECM-Kw1800 and ECM-Kc1810.

FIG. 19 is a diagram showing an example of a structure of a Kc distribution ECM 1900.

FIG. 20 is a diagram showing an example of a structure of the sublicense 1000 after inserting to the control information tag block 1500.

FIG. 21 is a functional block diagram showing a detailed configuration of a terminal apparatus 102 shown in FIG. 1.

FIG. 22 is a diagram showing an example of a structure of a data structure of a UL 2200.

FIG. 23 is a diagram showing an example of a structure of an ELI 2300.

FIG. 24 is a flowchart showing a processing performed for obtaining the main license 900.

FIG. 25 is a flowchart showing a subroutine of a license issuing permission judgement processing (S2404) shown in FIG. 24.

FIG. 26 is a flowchart showing a processing of generating the sublicense 1000 in the right management server 101a and a processing of transmitting a work key Kw203, a content key Kc205 and a sublicense 1000.

FIG. 27 is a flowchart showing an ECM generation processing and a content transmitting processing of the content distribution server 101b.

FIG. 28 is a flowchart showing process operations for viewing a content stored in a content storage unit 2103 in the terminal apparatus 102 by a user.

FIG. 29 is a flowchart showing a subroutine of a content use processing (S2806) shown in FIG. 28.

FIG. 30 is a flowchart showing process operations for time skipping of the content while viewing the stored content.

FIG. 31 is a flowchart showing operations for fast-forwarding the content (CM section) while viewing the stored content.

FIG. 32 is a flowchart showing operations for previewing the content while viewing the content.

### BEST MODE FOR CARRYING OUT THE INVENTION

Hereafter, it explains about the content reproduction control system according to an embodiment of the present invention with references to figures.

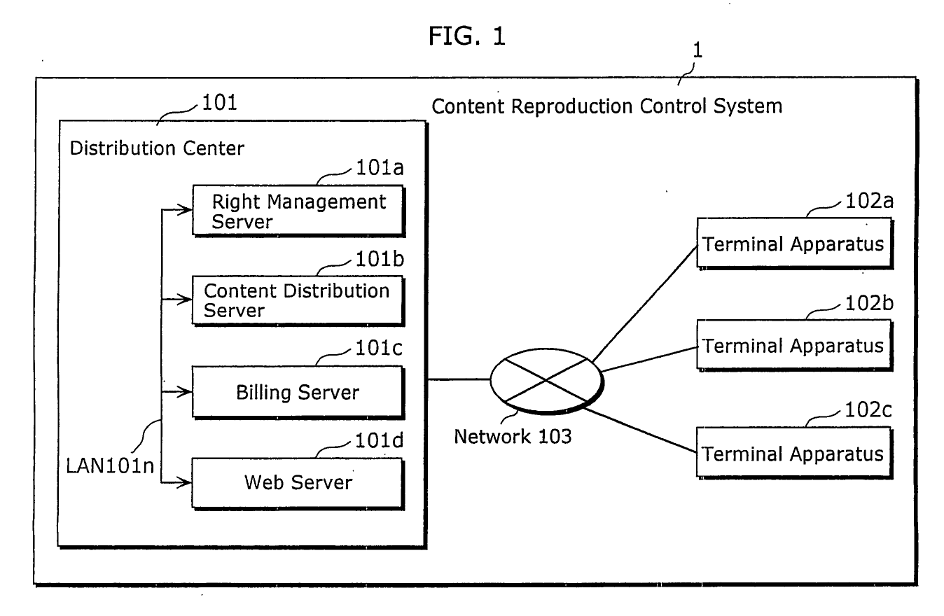

FIG. 1 is a diagram showing a conceptual configuration of a content reproduction control system 1 as a whole according to the embodiment of the present invention.

The content reproduction control system 1 is a system that securely controls a reproduction when a user uses in a terminal apparatus an encrypted content to be distributed from a distribution center (that is, a service provider) via a network and the like. As shown in FIG. 1, the system has a distribution center 101 that distributes a license and the like to give permission for a content and a content use, a plurality of terminal apparatuses 102a to 102c (three apparatuses are shown in the diagram) of using the content, and a network 103 such as Internet mutually connecting those.

The distribution center 101 includes a right management server 101a that manages the right (usage rules) of using the content held by the user; generates a license of the content; and distributes the license to the terminal apparatuses 102a to 102c, a distribution server 101b that distributes the content to the terminal apparatuses 102a to 102c, a billing server 101c that charges the user, a web server 101d that transmits a web screen for providing each service to the terminal apparatuses 102a to 102c through the network 103, and a LAN 101n mutually connecting those.

The right management server 101a is a server apparatus that manages the usage rules of the content held by the user and attaches a license for decrypting the content encrypted by the user. In specific, the right management server 101a manages the usage rules of the contents held by each user or each terminal apparatuses 102a to 102c, and distributes, in response to a request from a user, a license to the terminal apparatuses 102a to 102c through the network 103. Also, when a push-type content is distributed through the digital broadcast and a broadband Internet, a license may be distributed together with the content so that a generated license is transmitted to the content distribution server 101b.

Here, the license is made of an encryption key for decrypting the encrypted content, and usage rules such as restriction on the content use, the number of use and the like. An example of a data structure of the license is explained later in detail using figures.

Further, when data such as license to be secured is sent and received among the distribution center 101 and the terminal apparatuses 102a to 102c via the network 103, a Secure Authenticated Channel (hereafter also referred to as “SAC”) such as a Secure Socket Layer (SSL) and a Transport Layer Security (TLS) is set and data is sent and received.

The content distribution server 101b is a server apparatus that distributes the content to the terminal apparatuses 102a to 102c through the network 103, the server being realized by a specific hardware, a work station or the like. In specific, the content distribution server 101b is digitally compressed by a compression method such as MPEG-2 and MPEG-4, if necessary, encrypted by a common key encryption algorithm such as Advanced Encryption Standard (AES) and Triple Data Encryption Standard (DES), and distributes the encrypted content by streaming or downloading.

In particular, in a server-type broadcasting method in a digital satellite broadcasting and a terrestrial broadcasting, a method of distributing a stream-type content which can be commonly used for a real time viewing and a stored viewing is standardized and called as server-type broadcasting method type I, the stream type content multiplexing the contents of MPEG-2 and MPEG-4 (Elementary Stream, hereafter referred to as ES) by a Packetized Elementary Stream (PES) and a Transport Stream (TS).

Here, it is briefly explained about an encryption key scheme in a content distribution based on the server-type broadcasting method type I.

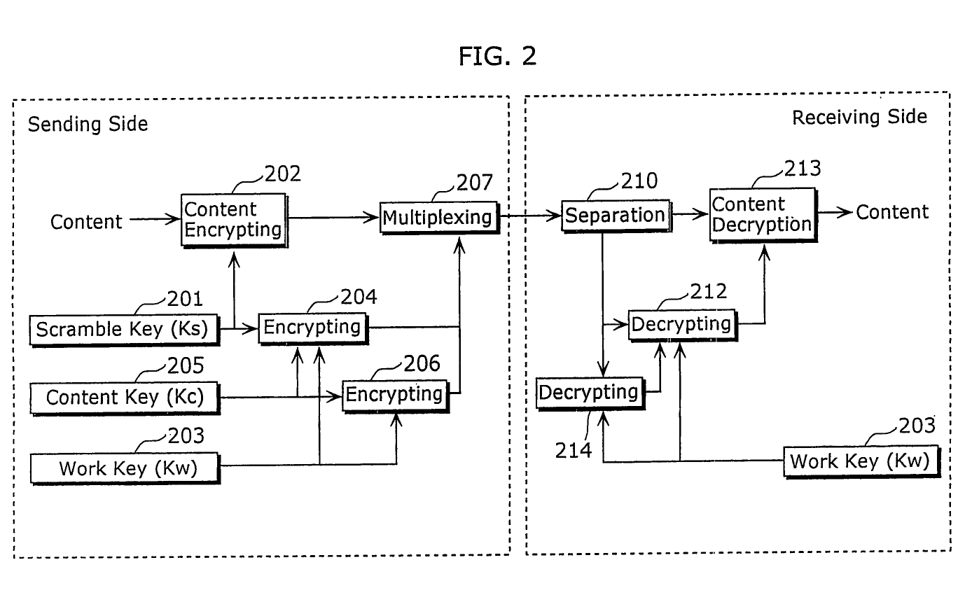

FIG. 2 is a diagram showing a sketch of the encryption key scheme.

Here, a sending side of distributing the content and the encryption key and receiving side of receiving the content and the encryption key are separately explained.

Firstly, on the sending side, the content is encrypted (202) with an encryption key called a scramble key Ks201, that is, scrambled, and sent to the receiving side. As for the scramble of the content, a payload of a TS packet is scrambled by each MPEG-2 TS packet as a unit. Also, the scramble key Ks201 is a time variant key which is changed for every few minutes in order to improve security against an illegal reception.

In addition, the scramble key Ks201 for scrambling the content is encrypted (204) with a work key Kw203 and sent to the receiving side. The work key Kw203 is an encryption key assigned for each group, contract with each broadcasting agency used in the conventional common limited receiving method. In order to secure the work key Kw 203 itself, in general, it is updated for every few months to few years. A data structure for sending information relating to the content including the scramble key Ks201 at least is called an Entitlement Control Message (ECM) and structured as a private section of the MPEG-2 systems. The ECM encrypted with the work key Kw203 is called ECM-Kw and used for the real time viewing of the broadcast content.

The scramble key Ks201 for scrambling the content is also encrypted (204) using a content key Kc205 and sent to the receiving side. The content key Kw205 is an encryption key assigned for each content and structured as a private section of the MPEG-2 systems similar to the ECM-Kw. The ECM encrypted with the content key Kc205 including the scramble key Ks201 at least is called as ECM-Kc and used for a stored viewing of the broadcast content.

Further, the content key Kc205 is encrypted with the work key Kw203 and transmitted to the receiving side. The ECM encrypted with the work key Kw203 including the content key Kc205 at least is called a Kc distribution ECM and used for a stored viewing of the broadcast content. The Kc distribution ECM is structured as a private section of the MPEG-2 Systems similar to the ECM-Kw and the ECM-Kc.

Note that, an example of data structures of ECM-Kw, ECM-Kc, Kc distribution ECM are explained later in detail with reference to figures.

The encrypted content generated as described above, ECM-Kw, ECM-Kc, and Kc distribution ECM are packeted in the MPEG-2 TS, and sent to the receiving side after being multiplexed (207) with data such as Program Specific Information (PSI) and Service Information (SI) if necessary.

On the other hand, on the receiving side, the MPEG-2 TS packet in which the encrypted content, the ECM-Kw, the ECM-Kc and Kc distribution ECM are multiplexed is received and separated (210) in order to respectively obtain the encrypted content, the ECM-Kw, the ECM-Kc, and the Kc distribution ECM.

When the content is viewed at real time, the ECM-Kw is obtained; the ECM-Kw is decrypted (212) with the work key Kw203 previously held at the receiving side; and the scramble key Ks201 is obtained. Accordingly, the encrypted content is decrypted (213) and the content use is allowed. Note that, the ECM-Kw is used only at the real time viewing so that it is not necessarily to be stored in a storage unit which is not shown in the diagram.

On the contrary, at the stored viewing, the encrypted content, the ECM-Kc, the Kc distribution ECM stored in the storage unit (not shown in the diagram) are readout. The Kc distribution ECM is decrypted (214) with the work key Kw203 and the content key Kc205 is obtained. Then, the ECM-Kc is decrypted (212) with the content key Kc205; the encrypted content is decrypted (213) and the content use is allowed.

Note that the ARIB STD-B25 version 4.1 describes, in addition to the above description, a method for sharing the work key Kw203 at the sending and receiving sides. However, in the present embodiment according to the present invention, it explains about a case where a SAC is established between the sending side and the receiving side and the work key Kw203 is shared through communication. As described in the ARIB STD-B25 version 4.1, using a data structure called Entitlement Management Message (EMM), the work key Kw203 may be shared between the sending side and the receiving side by distributing the work key Kw 203 through the broadcasting. In this case, in order to prevent the EMM to be listened, it is distributed by encrypting with a specific key for each receiving terminal called master key. The master key is an encryption key previously held in the sending and receiving sides. On the receiving side, it is managed in a secure place in the terminal apparatus 102 or shipped by being written previously in a module with high anti-tamper characteristic called security module and used by inserting the security module into the terminal apparatus 102.

Also in here, in order to store the Kc distribution ECM encrypted with the work key Kw203 into a storage unit (not shown in FIG. 2), an example of storing the Kc distribution ECM without an encryption transformation is described for a concise explanation. However, for a regular or an irregular update of the work key Kw203, an encryption transformation for the Kc distribution ECM may be performed using an encryption key (group key) shared previously among the plurality of terminal apparatuses or the master key specific to the terminal apparatus 102.

Hereafter, based on an encryption scheme on the basis of the server-type broadcast method type I, the content reproduction control system 1 according to the embodiment of the present invention is explained.

Back to FIG. 1, in order to further reproduce and control the content in the terminal apparatuses 102a to 102c, the content distribution server 101b generates reproduction control information for reproducing and controlling a specific part of the content based on attribute information previously set to the content and distributes the generated control information to the terminal apparatuses 102a to 102c together with the ECM.

The billing server 101c is a server apparatus for billing on line when purchasing usage rules of the content and the like via the Internet and the like. In specific, the billing server 101c charges and makes a payment using a credit card or, based on the records of purchases uploaded from the terminal apparatuses 102a to 102c via the network 103, by registering in advance a user's bank account number to the billing server 101.

The web server 101d provides a content purchasing screen for accessing each service from the terminal apparatuses 102a to 102c by a user. In specific, through the Internet using a protocol such as HTTP, the web server 101d provides a web page written in a script language such as Hyper Text markup Language .(HTML) and Extensible Markup Language (XML) and a page written in Broadcasting Markup Language (BML) in a digital broadcast.

The LAN 101n is a network for mutually connecting, in the distribution center 101, a right management server 101a, a content distribution server 10b, a web server 101d, and a billing server 101c. For example, it can be realized using a cable network such as IEEE802.3 or a wireless network such as IEEE802.11b.

The network 103 is a network mutually connecting the distribution center 101 to the terminal apparatuses 102a to 102c. For example, the network 103 is a communication network such as Internet, a digital broadcasting, or a composed network thereof.

The terminal apparatuses 102a to 102c are a terminal apparatus having a function of connecting to the network 103, and a monitor screen on which the user uses the content, the terminal apparatus being used for writing the content into the recording media. In specific, the terminal apparatuses 102a to 102c are a Set Top Box (STB) for receiving the digital broadcast, a content display apparatus such as a digital TV, a Digital Versatile Disc (DVD) recorder, a HDD recorder, a Personal Computer (PC), a recorder or a composed apparatus thereof.

In the content reproduction control system 1 configured as described above, the following processing is explained in detail, the processing of distributing the content and the license through the network 103 such as a digital broadcast and a broadband Internet and viewing the content based on the license and the reproduction control information in the terminal apparatuses 102a to 102c. Note that, hereafter, the terminal 102a is used as a representative of the terminal apparatuses 102a to 102c and explained as a terminal apparatus 102.

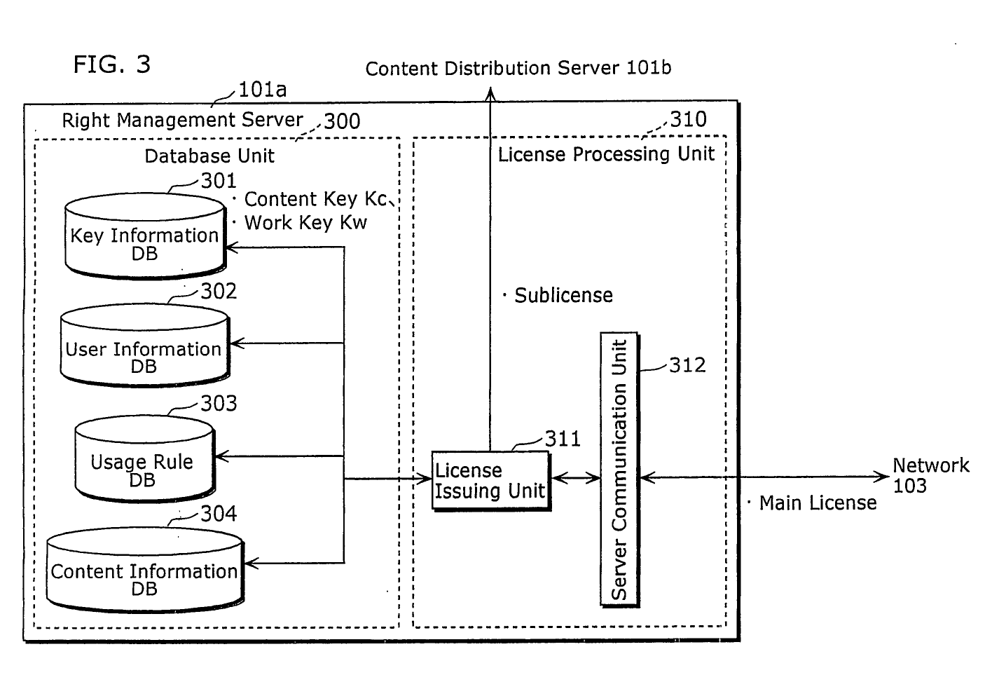

FIG. 3 is a functional block diagram showing a detailed configuration of the right management server 101a shown in FIG. 1.

The right management server 101a is mainly composed of a database unit 300 realized by data files stored in a HDD and the like and a license processing unit 310 realized by a program and the like executed using a hardware such as system LSI, or CPU, RAM, and ROM.

The database unit 300 has key information DB 301, user information DB 302, usage rules DB 303, content information DB304 and the like.

The key information DB 301 is a database managing a work key Kw203 given by signing for a service between the user and a service provider and a content key Kc 205 assigned for each content for stored viewing respectively in a work key management table and in a content key management table. It is used when the content distribution server 101b generates the ECM-Kw, the ECM-Kc, and the Kc distribution ECM, to provide the work key Kw 203 and the content key Kc 205, and when the terminal apparatus 102 requests the license including the work key Kw 203, to search the work key Kw 203 in compliance with the contract (contract ID) of the user.

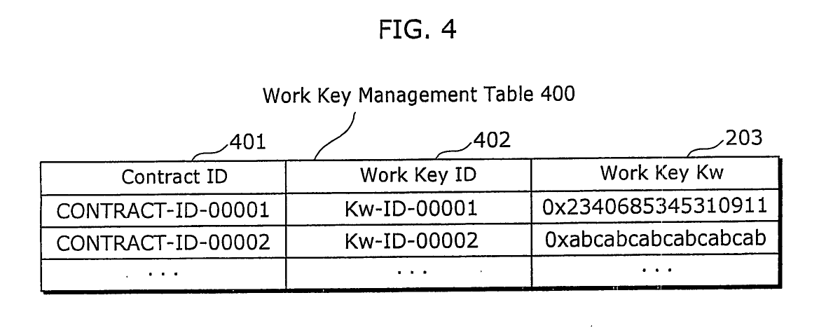

FIG. 4 is a diagram showing an example of a structure of the work key management table 400 included in the key information DB 301.

As shown in FIG. 4, the work key management table 400 has each fields of an contract ID 401, a work key ID 402 and a work key Kw 203 and manages a pair of the work key ID 402 with the work key Kw 203 corresponding to the contract ID 401.

For example, in FIG. 4, the work key ID 402 corresponding to the contract ID 401 of “CONTRACT-ID-00001” is “Kw-ID-00001” and the paired work key Kw 203 is “0x2340685345310911”. Here, the contract ID 401 indicates a type of a contract pattern toward a service provided by the provider. For example, it is a “sports content pack” that can view contents relating to sports, a ““movie content pack” that can view movie contents and the like. However, it is allowed to identify the contract ID 401 with usage rules set in the license and include the contract ID as an item of the ECM by assigning the work key Kw 203 to each service provider, but not by assigning the work key Kw 203 to each contract ID. The work key ID 402 is information used for identifying the work key Kw 203 which has encrypted the ECM.

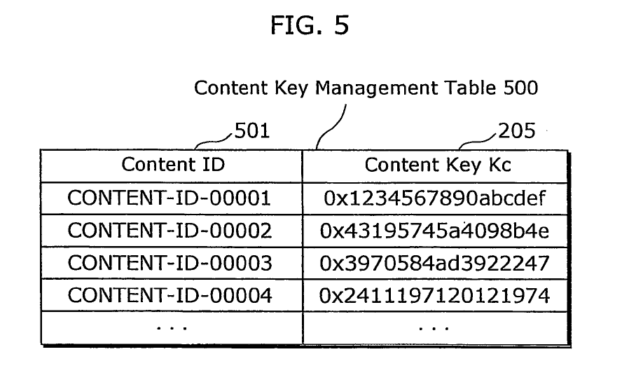

FIG. 5 is a diagram showing an example of a structure of the content key management table 500 included in the key information DB 301.

As shown in FIG. 5, the content key management table 500 has each field of a content ID 501 for uniquely identifying the content in the content reproduction control system 1 and the content key Kc 205 corresponding to the content ID 501, and manages the content key Kc using the content ID as a key.

For example, the content key Kc205 for decrypting the encrypted content with the content ID of “CONTENT-ID-00001” is shown as “0x1234567890abcdef”.

The user information DB 302 is a database having a user information management table for managing information related to users. It is used to associate the terminal apparatus 102 accessing to the right management server 101a with a user holding usage rules managed in the usage rule DB 303.

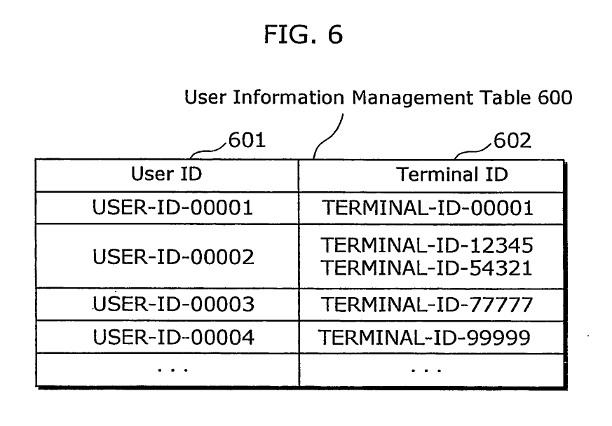

FIG. 6 is a diagram showing a structure of an example of a user information management table 600 included in the user information DB 302.

As shown in FIG. 6, the user information management table 600 has each field of a user ID 601 for uniquely specifying a user in the content reproduction control system 1 and a terminal ID 602 for uniquely specifying the terminal apparatus 102 in the content reproduction control system 1, and manages the user ID and the terminal ID.

For example, in FIG. 6, it is shown that a user with the user ID 601 of “USER-ID-00001” has the terminal apparatus 102 with the terminal ID 602 of “TERMINAL-ID-00001”. Also, a user with the user ID 601 of “USER-ID-00002” has two terminal apparatuses 102 with the terminal IDs 602 of “TERMINAL-ID-12345” and “TERMINAL-ID-54321”, indicating that both terminal apparatuses 102 can access to the right management server 110a.

Note that, a data registration to the user information DB 302 is performed when the user registers for a membership to receive services provided by the service provider. The membership registration processing may be performed online at the distribution center 101 and the terminal apparatus 102 by the user through a membership registration screen provided by the web server 101d via the network 103. Also, it may be performed offline using a post card for the member registration. In the member registration processing, the service provider firstly assigns a user ID 601 to the user. After that, the terminal ID 602 of the user's terminal apparatus 102 is notified by the service provider online or offline. Therefore, the user ID 601 and the terminal ID 602 are associated with each other and registered in the user information management table 600 of the user information DB 302. After the above mentioned membership registration processing, the user information DB 302 is constructed.

The usage rules DB 303 is a database managing usage rules regarding the contract between each user and the provider using the usage rules management table. Responding to a license obtainment request from the terminal apparatus 102, it judges whether or not the user satisfies the usage rules and the license is generated when the usage rules are satisfied.

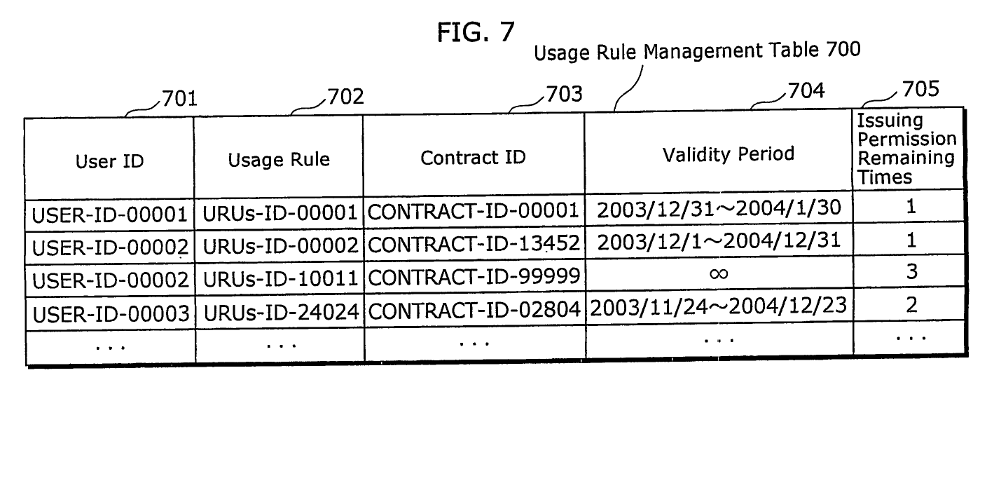

FIG. 7 is a diagram showing an example of a structure of a usage rule management table 700 included in the usage rules DB 303.

As shown in FIG. 7, the usage rule management table 700 has each field of a user ID 701 for uniquely identifying a user in the content reproduction control system 1 and indicating the owner of the usage conditions, a usage rule ID 702 for identifying the usage rules held by the user identified by the user ID 701, a contract ID 703 for uniquely identifying a contract pattern of the user in the content reproduction control system 1, a validity period 704 indicating a starting date and a termination date specified by the contract ID 703, a issuing permission remaining times 705 indicating the number of remaining times of permitted issuing of a license in compliance with the contract pattern indicated by the contract ID 703, and manages the user's usage rules using the user ID as a key.

For example, a user with the user ID 701 of “USER-ID-00001” has usage rules with the usage rule ID 702 of “URUs-ID-00001”. The usage rules shown as “URUs-ID-00001” is a contract between the user and the provider indicated by the contract ID 703 of “CONTRACT-ID-00001” whose validity period 704 is 2003/12/31˜2004/1/30” and the number of remaining times of permitted issuing of a license is “1” time as shown in the number of remaining issuing permission times 705. Also, the user with the user ID 701 of “USER-ID-00002” has two usage rules ID 702 of “URUs-ID-00002” and “URUs-ID-10011”. Among them, the usage rule “URUs-ID-00002” is a usage rule toward the contract pattern with the contract ID 703 of “CONTRACT-ID-13452” whose validity period 704 is “2003/12/1˜2004/12/31” and the number of remaining issuing permission times 705 is “1”, which indicates that a license having the validity period can be issued once more. Also, the usage rules of “URUs-ID-10011” is usage rules of the contract pattern with the contract ID 703 of “CONTRACT-ID-99999” whose validity period 704 is unlimited (∞) and the number of remaining issuing permission times 705 is three times.

The content information DB 304 is a database having a content information management table storing usage rules for each content and is used for generating a license (a sublicense to be described later) set for each content.

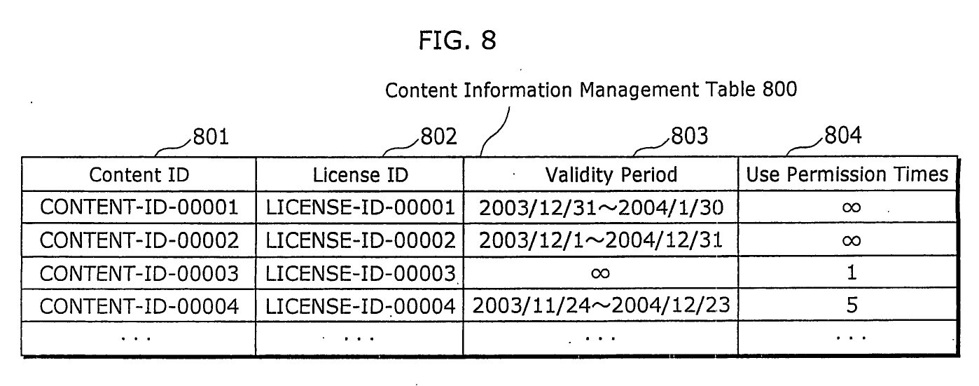

FIG. 8 is a diagram showing an example of a structure of a content information management table 800 included in the content information DB 304.

As shown in FIG. 8, the content information management table 800 has each field of a content ID 801 for uniquely identifying a content in the content reproduction control system 1, a license ID 802 for uniquely identifying a license in the content reproduction system 1, a validity period 803 indicating a validity period of the license, and a use permission times 804 indicating the number of times available for using the license, and manages the content usage rules using the content ID as a key.

For example, in FIG. 8, it is shown that the content with the content ID 801 of “CONTENT-ID-00001” has the license ID 802 of “LICENSE-ID-00001” whose validity period 803 is “2003/12/31˜2004/1/30” and the use availability times 804 is “∞ (unlimited)”. These values are set in the sublicense.

Next, it is explained in detail about each unit of the license processing unit 310.

The license processing unit 310 is composed of a license issuing unit 311 and a server communication unit 312 as shown in FIG. 3.

The license processing unit 311 is a unit for generating a license (a main license to be described later) for the user in response to a license issuing request from the terminal apparatus 102. Additionally, in order to send the content key Kc 205 to the terminal apparatus 102 together with the content via the digital broadcasting, the license issuing unit 311 issues a license (a sublicense described later) including the content key Kc 205 and sends to the content distribution server 101b.

In specific, the license issuing unit 311 receives a license issuing request from the terminal apparatus 102 and generates a license corresponding to the user's contract after judging whether or not the license issuing request satisfies user's usage rules using the user information DB 302 and the usage rules DB 303. A license that is issued for the user's contract and applicable to a plurality of contents corresponding to the contract is called a main license, which includes the work key Kw203 shown in FIG. 2.

On the other hand, the license sent to the content distribution server 101b is a license issued for single content and is called a sublicense. The sublicense includes the content key Kc205 shown in FIG. 2 and encrypted with the work key Kw203. Also, the sublicense is set to the ECM in the content distribution server 101b and sent to the terminal apparatus 102. Therefore, in order to use a content to which the sublicense is assigned, it is necessary to obtain a main license to which the work key Kw203 has been encrypting the sublicense.

The server communication unit 312 is a unit for communicating with the terminal apparatus 102 through the network 103.

Here, it explains in detail about the main license and the sublicense generated by the license issuing unit 311.

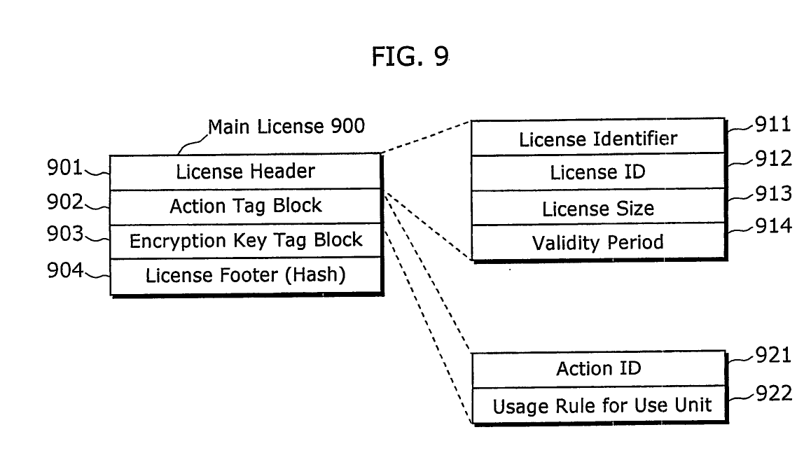

FIG. 9 is a diagram showing an example of a structure of the main license.

As shown in FIG. 9, a main license 900 is made of a license header 901, an action tag block 902, an encryption key tag block 903, and a license footer 904.

The license header 901 includes a group of contents whose use are permitted by the main license 900, that is, a contract ID for identifying a type of a subscription (contract) and a validity period (validity of the contract ) of the main license 900. The action tag block 902 indicates usage rules relating to a reproduction of a content and a copying into the recording media. The encryption key tag block 903 includes the work key Kw203 for decrypting the encrypted content key Kc205. The license footer 904 is a hash value for detecting an unfair alternation of the main license 900.

More in detail, the license header 901 is made of a license identifier 911 for identifying the main license 900, the license ID 912 which is an identifier for uniquely specifying the main license 900 for each user and system, a license size 913 showing a data length of the main license 900 as a whole, and a license validity period 914 indicating a period of time when the main license 900 is available.

The action tag block 902 more in detail includes an action ID 921 for specifying an action such as “play”, “copy”, or “print” by the user to the content and a usage rule for use unit 922 indicating a usage rule unique to a unit which reproduces, copies and the like the content. Here, the usage rule for use unit 922 is a usage rule depending on a type and a performance by a content use unit providing a function of using the content. For example, it includes specifying an audio channel of a movie content (can be reproduced at 5.1 ch or at 2 ch), resolving the movie content, specifying the size, and the like.

In the encryption key tag block 903, more in detail, the work key Kw203 is set at a binary value and is used for decrypting ECM including the sublicense such as ECM-Kw and Kc distribution ECM.

The license footer 904, more in detail, detects an unfair alternation and secures the correctness when the main license 900 is stored in a non-secure region such as a hard disk. It calculates a hash value of an area where the alternation of the main license 900 needs to be prevented and manages the calculation result every time when the content of the main license 900 is updated. The hash value needs to be managed in an area that is anti-tampered. As a specific hash algorithm, Secure Hash Algorithm 1 (SHA-1), SHA-256 and the like can be used.

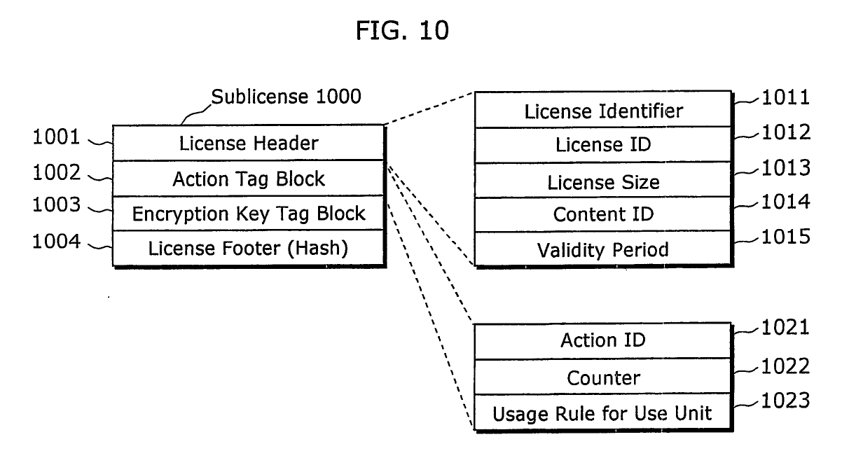

FIG. 10 is a diagram showing an example of a structure of the sublicense.

Similar to the main license 900, the sublicense 1000 is made of a license header 1001, an action tag block 1002, an encryption key tag block 1003, and a license footer 1004. Also, the license header 1001 has a license identifier 1011, a license ID 1012, a license size 1013, a validity period 1015, and further a content ID 1014. The action tag block 1002 has a counter 1022 in addition to an action ID 1021 and the usage rule for use unit 1023.

Compared to the main license 900, the sublicense 1000 specifies single content with which the sublicense 1000 permits the use so that it can set the content ID 1014 in the license header 1001. The action tag block 1002 has the counter 1022 indicating a usage rule such as the number of times permitted for reproducing the content and copying into the recording media. Also., in the encryption key tag block 1003, the content key Kc205 for decrypting the ECM-Kc is set in the binary value. Since other items in the sublicense 1000 are same as in the main license 900, the explanations about other items are omitted in here. Note that in the case where there are same items in the main license 900 and in the sublicense 1000, a value set in the sublicense 1000 is applied. However, it may determine which license to prioritize according to an operation.

Next, it is explained in detail about a configuration of a content distribution server 101b.

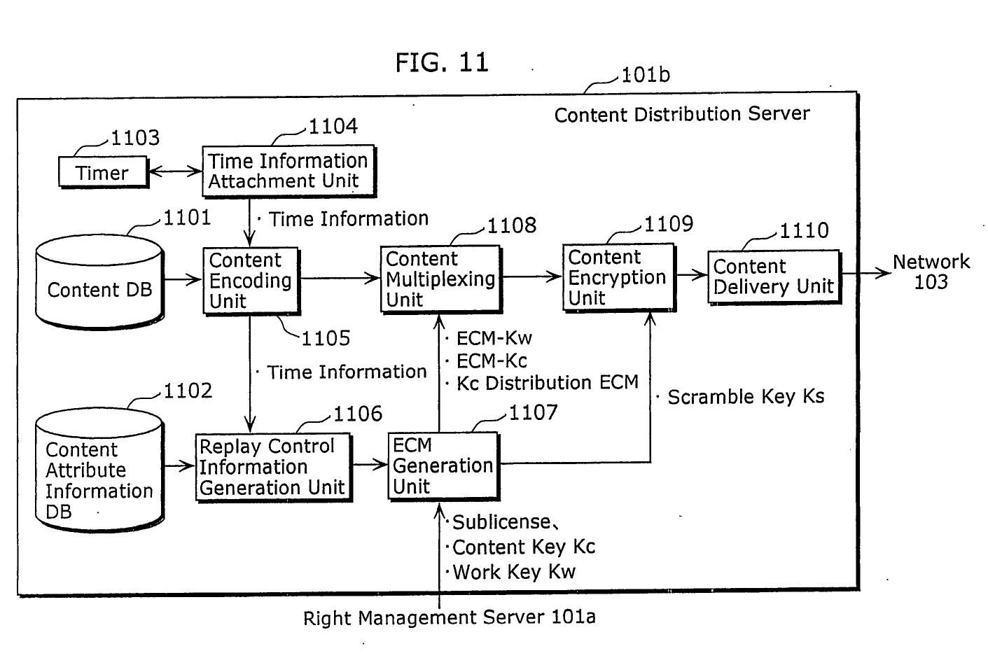

FIG. 11 is a functional block diagram showing a detailed configuration of the content distribution server 101b shown in FIG. 1.

The content distribution server 101b is an apparatus that outputs contents such as MPEG-2 and MPEG-4 in a format of a MPEG-2 TS packet. The apparatus includes a content DB 1101, a content attribute information DB 1102, a timer unit 1103, a time information attachment unit 1104, a content encoding unit 1105, a reproduction control information generation unit 1106, an ECM generation unit 1107, a content multiplex unit 1108, a content encryption unit 1109, a content delivery unit 1101 and the like.

The content DB 1101 is a database for storing contents. In specific, the content DB 1101 is, for example, a Video Cassette Recorder (VCR) storing a movie, a documentary and the like, or a video camera for shooting video and audio for live broadcast.

The content attribute information DB 1102 is a database having a content attribute information management table for storing various information related to a content such as a content title, information about structure within the content and the like.

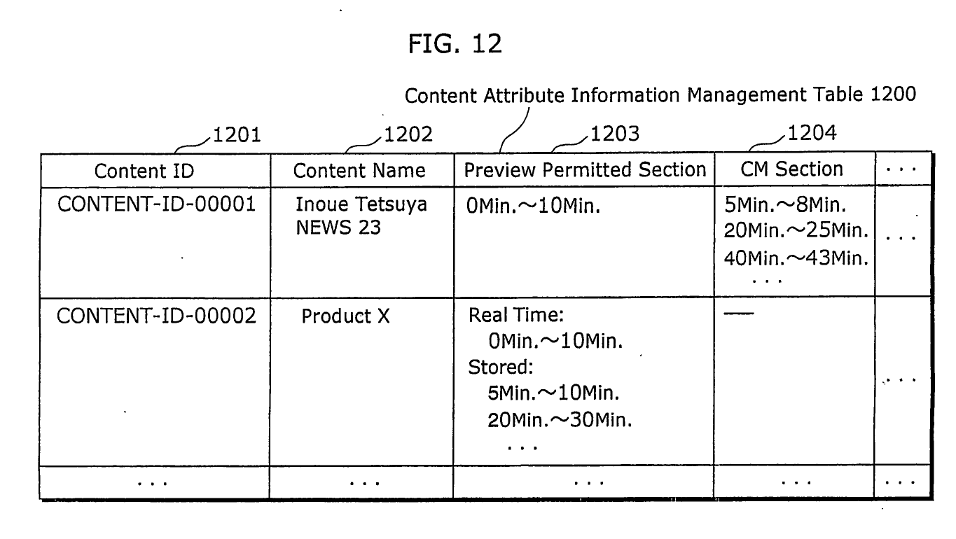

FIG. 12 is a diagram showing an example of a structure of a content attribute information management table 1200 included in the content attribute information DB 1102.

As shown in FIG. 12, the content attribute information management table 1200 has each field of a content ID 1201 for uniquely identifying a content in the content reproduction control system, a content title 1202 indicating a name of a content, a preview permitted section 1203 indicating a time range during which a preview is permitted before purchasing the content when the content is Pay Per View (PPV) type content, and a CM section 1204 indicating a CM section included in the content and manages various information relating to the content using the content ID as a key.

For example, the content with the content ID 1201 of “CONTENT-ID-00001” has attributes of the content title 1202 of “Inoue Tetsuya NEWS 23”, and the preview permitted section 1203 is “0 min. ˜10 min.” as a relative value from the beginning of the content, and the CM section 1204 is “5 min. ˜8 min.”, “20 min. ˜25 min.” and “40 min. ˜43 min.” as relative values from the beginning of the content. Also, the content ID 1201 of “CONTENT-ID-00002” whose content title 1202 is “product X” has different attributes of the preview permission section for the real time viewing (0 min. ˜10 min.) and the preview permission section for the stored viewing (5 min. ˜10 min., 20 min. ˜30 min. etc) and a content attribute suitable for a characteristic of the stored viewing is determined. Further, since the content does not include CM, the CM section 1204 is indicated as “−(no CM)”. Note that, the content in which the preview permission section 1203 is not set indicates that the preview is not permitted. Also, the content in which the CM section 1204 is not set indicates that a part where special reproduction is not prohibited in the content since the content does not include CM. Whereas the part is specified with precision by a minute time in here, it is needless to say that it may be specified with precision by a second time.

The timer unit 1103 is a unit that outputs time which becomes a basis in the content distribution server 101b. Specifically, the timer unit 1103 generates a standard time of 42 bit with an accuracy of 27 MHz called System Time Clock (STC) and supplies to the time information attachment unit 1104.

The time information attachment unit 1104 obtains time information from the timer unit 1103 and attaches it to the content encoding unit 1105. In specific, the time information attachment unit 1104 obtains a value of STC from the timer unit 1103 and attaches, to the content encoding unit 1105, according to a regulation of the MPEG-2 Systems, a time stamp for Presentation Time Stamp (PTS) and Decoding Time Stamp (DTS) with an accuracy of 700 ms at least. Also, according to the regulation of MPEG-2 Systems, a time stamp for a Program Clock Reference (PCR) with an accuracy of 100 ms at least is attached.

In here, it is explained as an example that the timer unit 1103 and the time information attachment unit 1104 are set outside the content encoding unit 1105 which is explained next. However, they may be set inside the content encoding unit 1105.

The content encoding unit 1105 is a unit reading a content to be transmitted to the terminal apparatus 102 and encoding the content in a MPEG format.

In specific, the content encoding unit 1105 is a real time encoder generating a MPEG stream, which reads video, audio and the like from the content DB 1101 according to an instruction from an upper system (e.g. a program operation management system etc.) and generates ES of the MPEG-2 and the MPEG-4 of the video, audio, and the like. Further, it generates a PES packet including these ES, lastly TS-packeted and transmitted to the content multiplex unit 1108.

Here, it is explained about a scheme of a structure of the PES packet.

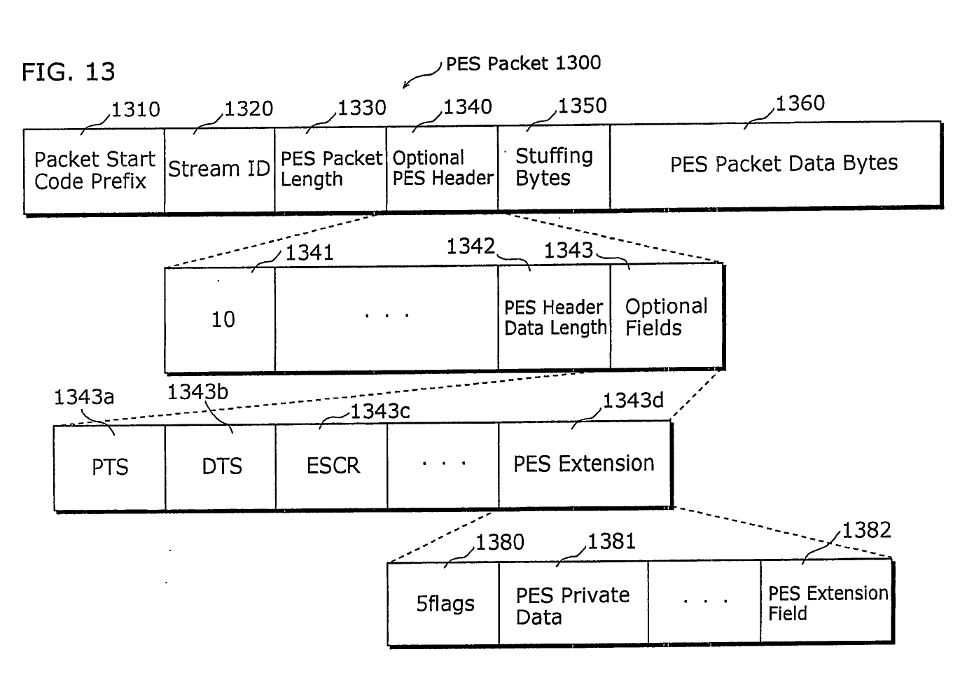

FIG. 13 is a diagram showing the scheme of the structure of the PES packet.

As shown in FIG. 13, the PES packet 1300 is made of a Packet Start Code Prefix 1310 which is a code indicating a start of the PES packet, a Stream ID 1320 indicating a type of data such as audio and video included in the PES, a PES Packet Length 1330 indicating data length of the PES packet 1300, an Optional PES Header 1340 which is an optional PES header, a Stuffing Bytes 1350 which is a stuffing, a PES Packet Data Bytes 1360 in which data (ES) such as audio and video are set.

The Optional PES Header 1340 includes elements of “10” field 1341, a PES Header Data Length 1342 and an Optional Fields 1343. Also, the Optional Fields 1343 includes elements of a PTS 1343a, a DTS 1343b, an ESCR 1343c and a PES Extension 1343d. Further, the PES Extension 1343d includes elements of 5flags 1380, PES Private Data 1381, and a PES Extension Field 1382.

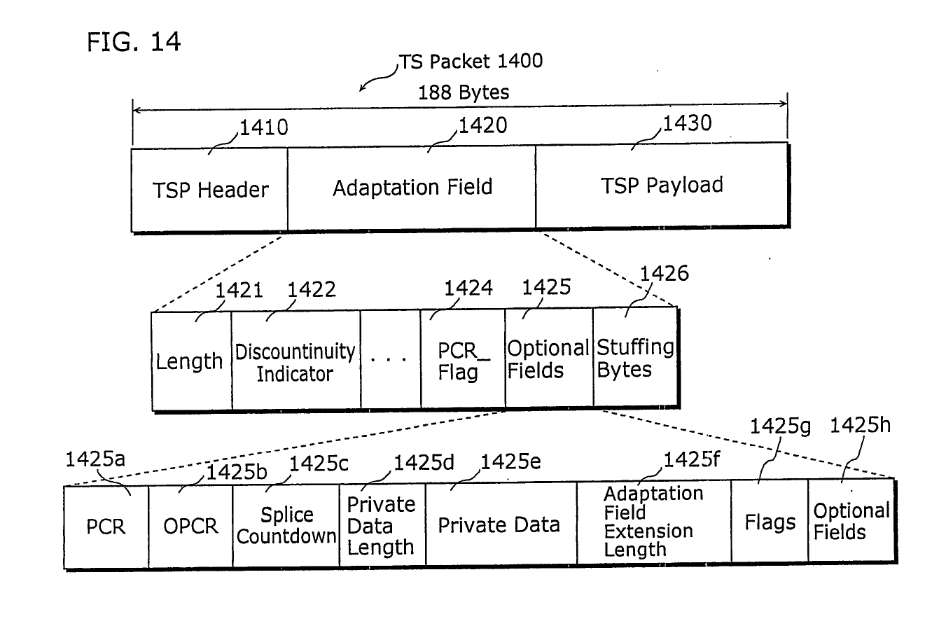

FIG. 14 is a diagram showing a scheme of a structure of a TS packet.

The TS packet 1400 is made of a TSP Header 1410, an Adaptation Field 1420, and a TSP Payload 1430.

The TSP Header 1410 is a header of the TS packet 1400 including a Packet ID (PID) for specifying a code indicating the start of the TS packet 1400 and a type of data set in the TS packet, a transport_scrambling_control which is a flag indicating whether or not payload of the TS packet (a TSP Payload 1430 to be described later) is encrypted, and the like.

The Adaptation Field 1420 is used as an option, in which time information and private data can be set.

The Adaptation Field 1420 includes elements of a Length 1421, a Discountinuity Indicator 1422, a PCR_Flag 1424, Optional Fields 1425 and Stuffing Bytes 1426. Also, the Optional Fields 1425 includes elements of a PCR 1425a, an OPCR 1425b, a Splice Countdown 1425c, a Private Data Length 1425e, an Adaptation Field Extension Length 1425f, Flags 1425g and Optional Fields 1425h.

The TSP Payload 1430 is a payload in which the TS packet 1400, PSI/SI and the like are set.

Note that, it is described in detail about the PES packet and the TS packet in the MPEG-2 Systems in ISO/IEC 13818-1 which is an international standard.

Next, it is explained about time information set by the content encoding unit 1105 using the PES packet explained in FIG. 13 and the TS packet 1400 explained in FIG. 14.

When the PES packet 1300 is generated using the time information obtained from the time information attachment unit 1104, that is, the value of STC, the content encoding unit 1105 attaches the PTS 1343a and the PTS 1343b that are elements of the Optional Fields 1343 in the optional header 1340 to the PES packet 1300. Note that, the PTS 1343a is information indicating time when video and audio included in the PES packet are displayed on the terminal apparatuses 102a to 102c. Further, the DTS 1343b is information indicating time when the video and audio included in the PES packet 1300 are decoded.

The. PTS 1343a and the DTS 1343b are set in an appropriate PES packet 1300 in order for each PES packet to be decoded and displayed certainly in the terminal apparatuses 102a to 102c when the PTS 1343a and the DTS 1343b agree with STC held in the terminal apparatuses 102a to 102c.

When generating the TS packet 1400, the content encoding unit 1105 attaches a PCR 1425a which is an element in the Optional Fields 1425 of the Adaptation Field 1420 in the TS packet 1400 using a value of time information (STC) obtained from the time information attachment unit 1104. Using the PCR 1425a, the terminal apparatuses 102a to 102c can reproduce a standard clock (STC) synchronous to STC of the transmission apparatus, the standard clock being a standard for synchronizing a plurality of ES (video, audio, data etc.).

Hereafter, return to FIG. 11, it is continuously explained about a configuration of the content distribution server 101b.

The reproduction control information generation unit 1106 is a unit generating information for controlling a reproduction of a specific part of content. In specific, the reproduction control information generation unit 1106 i) obtains the preview permission section 1203 and the CM section 1204 of a content corresponding to the content delivered from the content distribution server 101b from the content attribute information management table 1200 managed by the content attribute information DB 1102 and ii) generates the preview control information and the CM skip control information respectively corresponding as reproduction control information. In order to set the reproduction control information in the sublicense 1000 generated by the right management server 101a, the control information tag block which has a format settable in the sublicense 1000 is generated and the reproduction control information is set in the control information tag block.

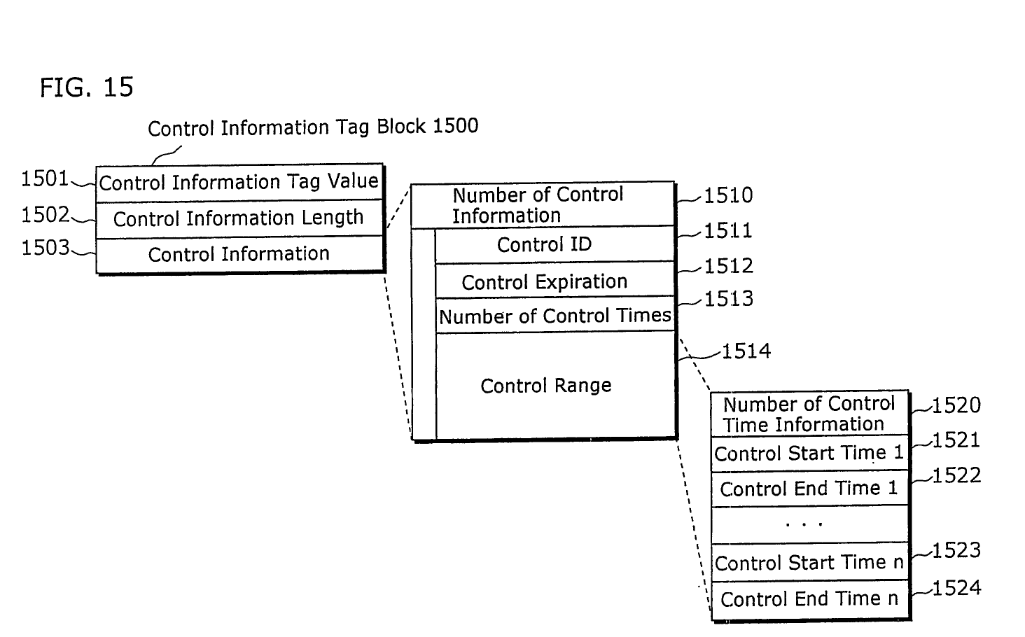

FIG. 15 is a diagram showing a data structure of the control information tag block.

As shown in FIG. 15, the control information tag block 1500 is made of a control information tag value 1501 indicating that the tag block is the control information tag block 1500, a control information length 1502 indicating a size of the control information tag block 1500, and control information 1503 indicating reproduction control information such as preview control information and CM skip control information. The control information 1503 includes a number of control information 1510 indicating a number of pieces of reproduction control information included in the control information 1503, a control ID 1511 indicating reproduction control contents, a control expiration 1512 indicating an expiration of the reproduction control, the number of control times 1513 indicating the number of controlling the reproduction, and a control range 1514 specifying a portion of the content to be reproduced and controlled using time information attached to the content. Further, the control range 1514 specifies the portion of the content to be reproduced and controlled using a pair of the control start time (1521, 1523) and the control end time (1522, 1524). Also, a plurality of the pairs of the control start time and the control end time included in the control range 1514 is possibly set. Therefore, it shows a number of pairs of the control start time and the control end time set in the control range 1514 as a number of time information control times 1520.

Herein, the preview permission section 1203 and the CM section 1204 in the content attribute information management table 1200 are relative time from the beginning of the content. Therefore, it is necessary to convert them into a value using time information (PTS1343a) actually attached to the content. The PTS 1343a is a clock value with 90 KHz so that it can be converted to a relative time based on the PTS 1343a from the beginning of the content by dividing the relative time with 90000 from the beginning of the content. Further, by obtaining a value of the PTS 1343a in the beginning of the content, the preview permission section and the CM skip control section can be expressed using the PTS 1343a attached to the content. The pair of the control start time and the control end time to be set in the control range 1514 is set as time information using the PTS 1343a.

By the way, reproduction control information including the control range 1514 is set in the sublicense 1000, further set in the ECM and distributed to the terminal apparatus 102 from the content distribution server 101b. Herein, a seamless reproduction of sequential contents is realized in the terminal apparatus 102 so that the ECM is delivered just before the content actually starts. Therefore, it is necessary to generate the reproduction control information before coding and delivering the content so that, in the generation of the reproduction control information, the PTS 1343a in the beginning of the content needs to be obtained by calculation.

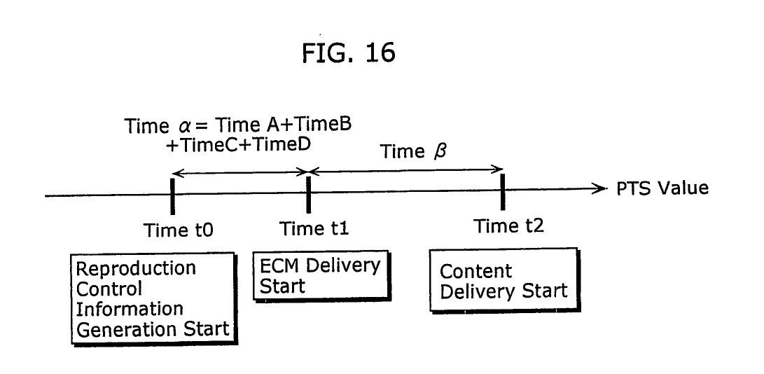

FIG. 16 is a conceptual diagram indicating a method of calculating the PTS 1343a in the beginning of the content. Note that, FIG. 16 shows an example in the case where the distribution of the content starts at time t2 from the content distribution server 101b to the terminal apparatus 102.

As described above, the content distribution server 101b needs to distribute the ECM at the time as long as β (time t1) before the delivery of the content is started. Herein, a timing of generating the reproduction control information (time t0) needs to be determined considering the amount of time α required for generating the reproduction control information and the ECM. Here, α is described as a total of time A to time D. As specific values of the time A to time D: the time A is time required for obtaining a value for the PTS at the time t0 from the content encoding unit 1105; the time B is time for calculating a value for the PTS in the beginning of the content; the time C generates the-reproduction control information and time required to be set in the sublicense 1000; and the time D is time required for generating the ECM and encrypting with the work key Kw203 and the content key Kc205. That is, the value of the PTS 1343a at the starting time of the content delivery (PTS 1343a in the beginning of the content) can be calculated as a value of adding time α and time β to the value of PTS 1343a obtained from the content encoding unit 1105 at time t0.

In here, it shows an example in the case where the values of the PTS 1343a calculated at the control start time and the control end time are set as the control range 1514. However, it can be set the value of the PTS 1343a in the beginning of the content separately to the reproduction control information and the like by setting a relative time from the beginning of the content using the value of the PTS 1343a as the control range 1514. Accordingly, the amount of calculation of the time information in the generation processing of the reproduction control information (relevant to the time C described above) can be reduced-.

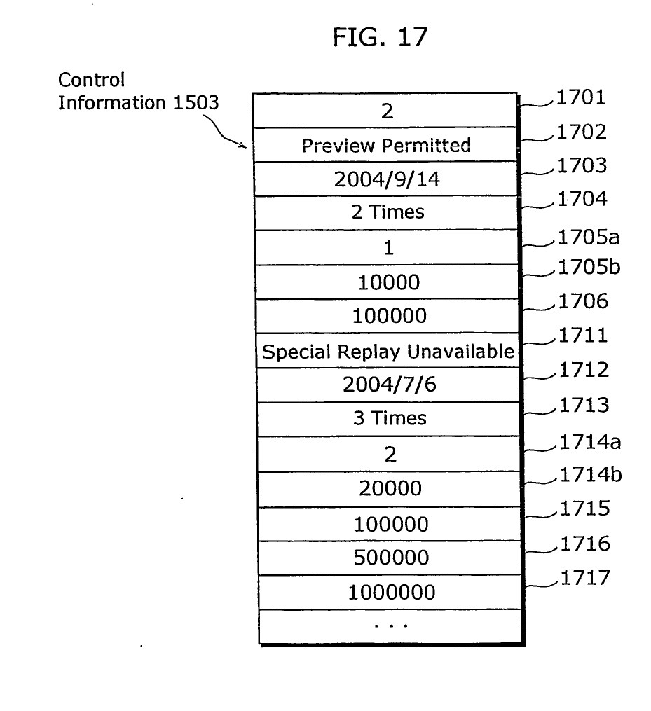

FIG. 17 shows an example of the reproduction control information (control information 1503) generated as above described. Hereafter, it is explained with references to FIG. 15 and FIG. 17.

In FIG. 17, a number of control information 1510 is “2” (1701), as described later, which is composed of two information of information for a preview control and information for a CM skip control.

As the first information, it is shown that the control ID 1511 is “preview permitted” (1702), the control expiration 1512 is “2004/9/14” (1703), the number of control times 1513 is “1 time” (1704), the control range 1514 is “1. 10000˜100000” (1705, 1706). Therefore, as the preview control relating to the content, it is indicated that a part with the PTS 1343a value of 1000 to 100000 is allowed to be previewed once a part where the preview is allowed until the period of time 2004/9/14. Here, as for the number of control times 1513, it is realized by recording the PTS 1343a of the reproduced content part as a viewing records and managing how many times the part are viewed when the content is used in the terminal apparatus 102.

As the second information, it is shown that the control ID 1511 is “special reproduction unavailable” (1711), the control expiration 1512 is “2004/7/6” (1712), the number of control times 1513 is “3 times” (1713), the control range 1514 is “2. 20000˜100000” (1714, 1715) and ““500000˜1000000” (1716, 1717) and the like. Therefore, as a special reproduction control relating to the CM part of the content, it is shown to control a part with the PTS1343a value of 20000 to 100000 and 500000 to 1000000 as a part where the CM skipping is not permitted at three times by a normal reproduction.

The control information tag block 1500 including the reproduction control information generated as above described is set in the sublicense 1000 and further set in the ECM so that it is sent to the ECM generation unit 1107. Note that, an ID of the license which set the reproduction control information may be set in the reproduction control information in order to clearly identify which reproduction control information corresponds to which license.

Hereafter, return again to FIG. 11, it is continued explaining about the configuration of the content distribution server 101b.

The ECM generation unit 1107 is a unit generating an ECM including the scramble key Ks201 and the sublicense 1000. In specific, the ECM generation unit 1107 receives, from the right management server 101a, the work key Kw203 and the content key Kc205, the sublicense 1000 and receives, from the reproduction control information generation unit 1106, the control information tag block 1500. Then, according to an instruction sent from the ECM generation unit 1107 and an upper system, the ECM-Kw, the ECM-Kc, and the Kc distribution ECM are generated; the scramble key Ks201 generated by the scramble key generation unit (not shown in FIG. 11) for a content is set; the control information tag block 1500 is inserted into the sublicense 1000 and set as the Kc distribution ECM. Further, the ECM generation unit 1107 encrypts the generated each ECM with the work key Kw203 and the content key Kc205 and sends the generated ECM to the content multiplex unit 1108. Also, the ECM generation unit 1107 sends the generated scramble key Ks201 to the content encryption unit 1109 which encrypts the content.

Here, it is explained in detail about the data structure of the ECM-Kw, the ECM-Kc, and the Kc distribution ECM data.

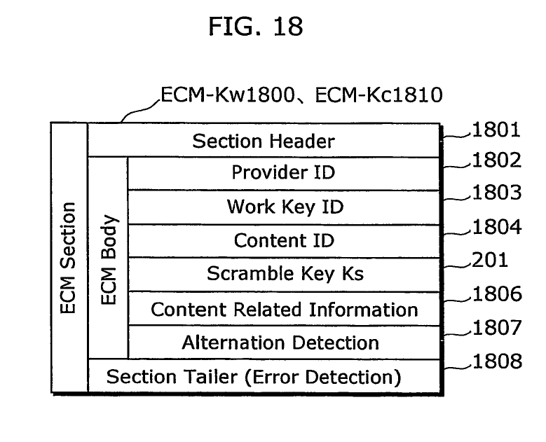

FIG. 18 is a diagram showing an example of a data structure of the ECM which mainly transmits the scramble key Ks210. In the terminal apparatus 102, the format of an ECM-Kw1800 encrypted with the work key Kw203 for the real time viewing and the format of an ECM-Kc1810 encrypted with the content key Ks205 for the stored viewing are same and only the encryption keys (the work key Kw203 and the content key Ks205) for encrypting the content differ.

The ECM-Kw1800 and the ECM-Kc1810 shown in FIG. 18 are information used for transmitting the scramble key Ks201 and information relating to the content, including a provider ID 1802, a work key ID 1803, a content ID 1804, a scramble key Ks201, a content related information 1806, and an alternation detection 1807. Also, in order to multiplex into a transport stream in a private section format of the MPEG-2 systems, a section header 1801 and a section tailer (error detection) 1807 are attached to the ECM-Kw1800 and the ECM-Kc1810.

The provider ID 1802 is a code for identifying a provider who provides a service in the content reproduction control system 1, which is referred together with the work key ID 2803 to be described next.

The work key ID 1803 is information for identifying the work key Kw203 for encrypting the ECM, which is set to a non-encryption part of the ECM. When the encrypted ECM is decrypted, with reference to the work key ID 1803, it can be judged which work key Kw203 should be used for decrypting the ECM.

The content ID 1804 is an identifier assigned for each content and is used for uniquely identifying the content in the content reproduction control system 1.

The scramble key Ks201 is an encryption key for encrypting a payload in the TS packet 1400 of the content (TSP-Payload1430). In general, a plurality of encryption keys are set to the scramble key Ks201 in order for the terminal apparatus 102 to reduce the amount of time required for obtaining the scramble key Ks201 to be changed for every few seconds.

The content related information 1806 is a variable length data to which information indicating an attribute of the content and the like is attached when it is necessary.

A hash value for detecting an unfair alternation of the ECM to be encrypted is set to the alternation detection 1807.

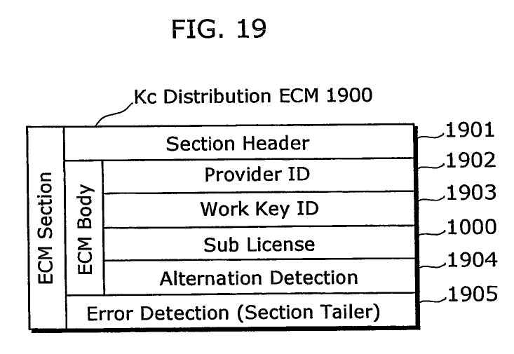

FIG. 19 is a diagram showing an example of a data structure of the Kc distribution ECM which mainly transmits the content key Kc205 for decoding the ECM-Kc1810 for the stored viewing.

As shown in FIG. 19, the Kc distribution ECM 1900 is information used for transmitting the content key Kc205 and the sublicense 1000, including a provider ID 1902, a work key ID 1903, a sublicense 1000, and an alternation detection 1904. The content key Kc205 and the content ID are included in the sublicense 1000. Also, similar to the ECM-Kw 1800 and the ECM-Kc 1810, a section header 1901 and a sector tailer 1905 (error detection) are attached to the Kc distribution ECM 1900.

The similar explanations could be provided for the provider ID 1902, the work key ID 1903, and the alternation detection 1904 as for the provider ID 1802 in the ECM-Kw 1800 and the ECM-Kc 1810, the work key ID 1803 and the alternation detection 1808. Therefore, those explanations are omitted in here.

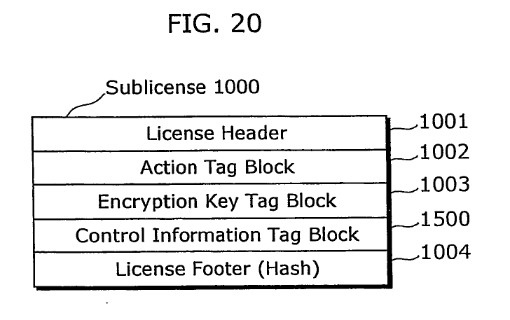

Also, as for the sublicense 1000 in the Kc distribution ECM 1900, as shown in FIG. 20, it has a data structure which the control information tag block 1500 obtained from the reproduction control information generation unit 1006 is inserted to the sublicense 1000 obtained from the right management server 101a. Each item of the sublicense 1000 and the control information tag block 1500 has been explained in FIG. 10 and FIG. 15. Therefore, the explanation is omitted.

Note that, time information can be included in the ECM-Kw1800, the ECM-Kc1810 and the Kc distribution ECM 1900. Herein, each ECM is encrypted and distributed so that, in particular for the real time viewing, the viewing control using secure time information set in the ECM can be realized.

Hereafter, return again to FIG. 11, it is continued explaining about a configuration of the content distribution server 101b.

The content multiplex unit 1108 i) multiplexes a transport stream including video, audio and data received from the content encoding unit 1105 with a transport stream including one or a plurality of ECMs received from the ECM generation unit 1107 and ii) delivers the multiplexed transport stream to the content encryption unit 1109. Specifically, the content multiplex unit 1108 i) multiplexes a TS packeted content received from the content coding unit 1105, the TS packeted ECM-Kw1800, ECM-Kc1810 and Kc distribution ECM 1900 received from the ECM generation unit 1107 and ii) generates a transport stream for to be delivered to the terminal apparatus 102.

The content encryption unit 1109 securely binds the protection of content and time information to the content by encrypting the content using AES and the like. Specifically, the content encryption unit 1109 encrypts (scrambles) the payload except an adaptation field in the TS packet, using the scramble key Ks201 obtained from the ECM generation unit 1107 in a Cipher Block Chaining (CBC)+Output Feed Back (OFB) mode. Accordingly, it securely binds the time information to the content.

The content delivery unit 1110 delivers the TS packet 1400 encrypted in the content encryption unit 1109 to the terminal apparatus 102. Specifically, the content delivery unit 1110 transmits the transport stream received from the content encryption unit 1109 as broadcast wave to the terminal apparatus 102 through the network 103.

In here, it shows an example of the case where the content stored in the content DB 1101 is read and encrypted for real time in the content encoding unit 1105. However, PES (ES) or TS are generated offline in advance so that the encoding processing at the content delivery in the content encoding unit 1105 may be omitted.

Also in here, whereas a non encrypted content stored in the content DB 1101 is encrypted in the content encryption unit 1109 when the content is distributed, the pre-encrypted MPEG-2 TS content can be stored.

Note that detailed configurations of the billing server 101c and the web server 101d in the distribution center 101 are not the main purpose of the present invention. Therefore, those explanations are omitted in here.

Next, a configuration of the terminal apparatus 102 in the content reproduction control system 1 is explained.

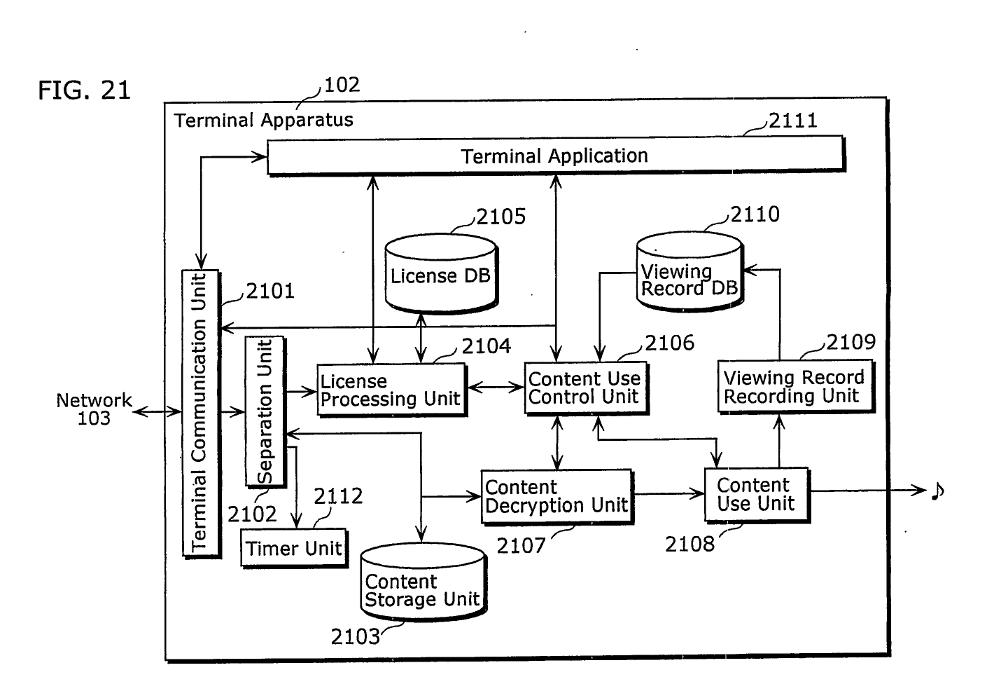

FIG. 21 is a functional block diagram showing a detailed configuration of the terminal apparatus 102 shown in FIG. 1.

The terminal apparatus 102 is made of a terminal communication unit 2101 which provides a communication interface with outside, a separation unit 2102 which separates the received transport stream into content and data other than the content, a content storage unit 2103 which stores contents, a license processing unit 2104 which processes and manages a license, a license DB 2105 which stores the license, a content use control unit 2106 which securely controls the use of content, a content decryption unit 2107 which decrypts the encrypted content, and a content use unit 2108 which uses the content, a viewing record recording unit 2109 which records viewed part of the content as a viewing record, a viewing record DB 2110 which stores the viewing records, a terminal application 2111 which provides an interface mainly to a user, and a timer unit 2112 which securely clocks.

The terminal communication unit 2102 is a unit for communicating with the distribution center 101 through the network 103.

The separation unit 2102 i) obtains the encrypted content multiplexed by the MPEG-2 TS, ii) refers PSI information such as Program Association Table (PAT), Program Map Table (PMT) included in the transport stream, iii) obtains a PID of the TS packet 1400 in which the TS packet 1400 and the PCR 1425a including video, audio and data of a content, the ECM-Kw1800, the ECM-Kc1810 and the Kc distribution ECM 1900 are inserted, and iv) separates the content from the ECM. Additionally, the separation unit 2102, at the same time, refers to the PCR_PID listed in the PMT (PID which includes PCR), obtains the TS packet 1400 of the PID in which PCR 1425a is inserted in the Adaptation_field 1420 of the TS packet 1400, and supplies to the timer unit 2112 as a standard clock for the content reproduction in the terminal apparatus 102. Also, when the content is temporally stored in the content storage unit 2103, the separation unit 2102 selects necessary information from the PSI information such as PAT and PMT, generates the PSI information such as Selection Information Table (SIT) and Discontinuity Information Table (DIT), and generates a stream called a partial transport stream (hereafter referred to partial TS) from the received transport stream.

The content storage unit 2103 stores the generated partial TS. Specifically, the content storage unit 2103 is realized in the large capacity HDD and the like and stores the partial TS generated from the transport stream received at the separation unit 2102.

The license processing unit 2104, based on the license, securely judges whether or not use of the content is permitted. Specifically, the license processing unit 2104 judges, when the user requested the use of content, whether or not the content can be used based on the main license 900 obtained from the right management server 101a or the usage rules included in the sublicense 1000 obtained together with the content. Then, so far as the usage rules permits the use of content, it gives an encryption key for decoding the encrypted content to the control unit 2106.

For example, the license processing unit 2104 refers the validity period 914 set in the license header 901 of the main license 900 and judges whether or not the content can be used. Referring to the secure present time provided by the timer unit 2112 held in. the terminal apparatus 102, when the present time is within the validity period 914, the license processing unit 2104 judges that a reproduction of the content is permitted.

Here, among the license processing unit 2104, the content use control unit 2106 and the content decryption unit 2107, the content key Kc205 is securely sent and received so that a SAC is established and the content key Kc205 is safely sent and received. However, when the license processing unit 2104, the content use control unit 2106 and the content decryption unit 2107 are located in a same anti-tamper region such as in the same system LSI, the content key Kc205 can be safely sent and received. Therefore, the establishment of SAC is not the necessity process.

The license DB 2105 is a database for securely managing the license and storing the main license 900 and the like obtained from the license processing unit 2104. Specifically, the license DB 2105 stores and manages the main license 900 and the like obtained from the right management server 101a shown in FIG. 9, and stores the hash value for the main license 900 and the like in the license DB 2105, in order to prevent illegal operations such as an alternation, into a region where a software or a hardware is anti-tampered.

The content use control unit 2106 securely controls the use of content using the work key Kw203 and the usage rules from the license processing unit 2104. Specifically, the content use control unit 2106, during the real time viewing, obtains the TS packet 1400 of the ECM-Kw1800 from the transport stream received from the separation unit 2102 and restructures the ECM-Kw1800. The content use control unit 2106 then decrypts the ECM-Kw1800 obtained as described above with the work key Kw203; obtains the scramble key Ks201 for descrambling the content; and supplies to the content decryption unit 2107. During the stored viewing, the content use control unit 2106 decrypts the Kc distribution ECM 1900 with the work key Kw203 from the transport stream read out from the content storage unit 2103 and obtains the sublicense 1000. Then, after judging the usage rules included in the sublicense 1000, the content use control unit 2106, only when the content can be used, decrypts the ECM-Kc1810 with the content key Kc205 included in the sublicense 1000 and obtains the scramble key Ks201.

Further, the content use control unit 2106 clocks used time of the content using the secure timer unit 2112 and controls the content use according to the usage rules.

The content decryption unit 2107 decrypts the encrypted content. Specifically, the content decryption unit 2107 i) obtains the content multiplexed by the encrypted MPEG-2 TS, ii) refers to the PSI information such as PAT and PMT included in the transport stream, and iii) obtains the PID of the TS packet in which the TS packet and the PCR including video, audio, data of the content are inserted. Then, it decrypts a payload of the TS packet 1100 encrypted by referring to transport_scrambling_control (not shown in FIG. 14) included in the TSP Header 1410 using the scramble key Ks201 obtained from the content use control unit 2106.

The content use unit 2108 decodes the content and outputs to a monitor and the like not shown in FIG. 21. Specifically, the content use unit 2108 obtains the PCR 1425a in the transport stream and synchronizes, with a function of Phased Lock Loop (PLL) included in the content use unit 2108, the STC (timer unit 1103) of the content distribution server 10 1b and the STC included in the content use unit 2108 (not shown in the diagrams). Then, it obtains data of the PES packet 1300 from the TSP Payload 1430 of the TS packet 1400, decodes ES such as video, audio and data of the MPEG-2 and MPEG-4, and outputs to the monitor. Furthermore, it notifies a use termination notice to the content use control unit 2106 when the use of content is terminated.

The viewing record recording unit 2109 corrects information about a viewed part of the content viewed in the content use unit 2108 as viewing records. Specifically, the viewing record recording unit 2109 obtains PTS 1343a at which the reproduction is started and ended in the content use unit 2108, receives the value of the PTS 1343a as the viewing record and stores into the viewing record DB 2110 as Usage Log (hereafter referred to as UL). It is explained later in detail about a data structure of the UL using figures.

The viewing record DB 2110 is a database for storing UL obtained from the viewing record recording unit 2109.

Here, the data structure of the UL is explained.

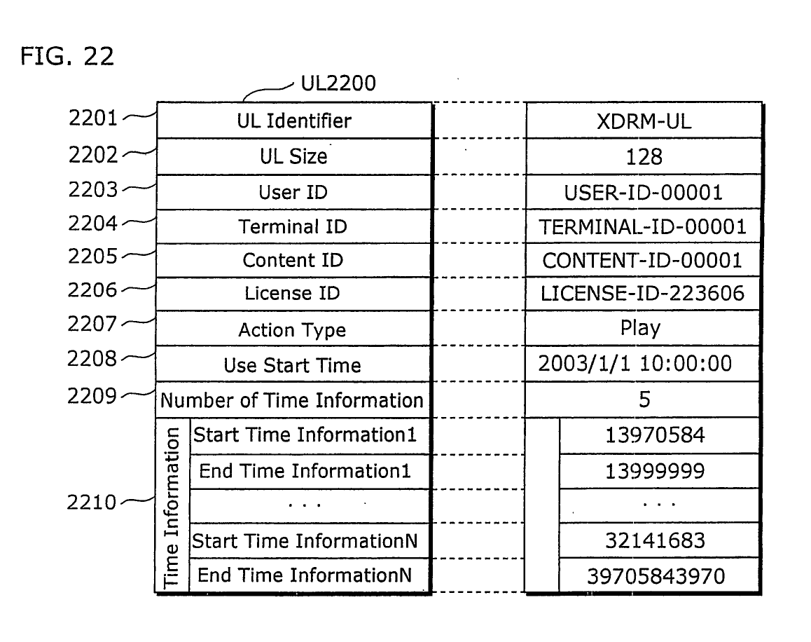

FIG. 22 is a diagram showing an example of a structure of the data structure of the UL.

A UL 2200 has a UL identifier 2201 which is an identifier that can be uniquely identified by each user, a UL size indicating a size of the UL 2200 as a whole, a user ID 2203 for specifying a user who has generated the UL 2200, a terminal ID 2204 for specifying the terminal apparatus 102 which has generated the UL 2200, a content ID 2205 for associating the content used by the user with the UL 2200, a license ID 2206 for associating the license used by the user (the main license 900 and the sublicense 1000) with the UL 2200, an action type 2207 for specifying a context (type.) about which the user has operated the content, a use start time 2208 which is an absolute time when the user started operating the content, number of time information 2209 which indicates a number of time information 2210 set in the UL 2200, and time information 2210 which are values of time information (PTS 1343a of the PES packet 1300) at which the content use is started and terminated.

Here, the license ID 2206, for example, in the case where it is in a control reproduction control system which returns the main license 900 from the terminal apparatus 102 to the right management server 101a, can associate the main license 900 used by the user with the sublicense by collecting the UL 2200 together with the main license 900. Therefore, the distribution center 101 can associate the viewing records with the license and manage them.

The action type 2207 is a type for specifying actions such as “play”, “copy”, and “print” for the content by the user. For the type, the value of the action ID 1021 in the sublicense 1000 is set. Here, it is shown an example of “play” which indicates a reproduction of the content.

Furthermore, the time information 2210 is information for specifying a part of the content used by the user, including pairs of start time information which is time information indicating the time when the content use is started, with end time information which is time information indicating the time when the content use is terminated, as many as the number of the pairs are defined in the number of time information 2209. Here, it is shown that there are N numbers of the pair of “start time information, end time information”, the “start time information 1, end time information 1” is “13970584, 13999999” and the “start time information N, end time information N” is “32141683, 39705843970”.

Note that, there is no hash value and the like for detecting an unfair alternation of the UL 2200 in the UL 2200. However, it is allowed to add the alternation detection when it is necessary.

Further, it may be transmitted to the distribution center 101 at arbitral timing or regularly when it is necessary.

The terminal application 2111 is a unit of obtaining the main license 900 from the right management server 101a and providing an interface that instructs start and end of the content use and the like. Specifically, the terminal application 2111 generates Expected License Information (hereafter referred to as ELI) as an obtainment request of the license in compliance with the user's contract, transmits to the right management server 101a and obtains the license from the right management server 101a.

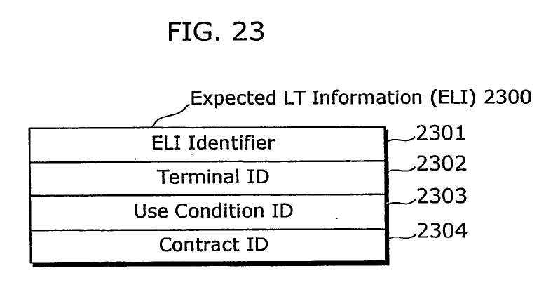

FIG. 23 is a diagram showing an example of the ELI.

The ELI 2300 includes an ELI identifier 2301, a terminal ID 2302, a usage rule ID 2303, and a contract ID 2304. For the ELI identifier 2301, information indicating that the data is ELI 2300 is written. For the terminal ID 2302, a terminal ID of the terminal apparatus 102 which has generated the ELI 2300, that is, the terminal 102 which requests the license is written. For the usage rule ID 2303, the usage rule ID 702 for specifying the usage rule of the user managed in the usage rule DB 303 of the right management server 101a is written. For the usage rule ID 702, a usage rule ID which is notified as a response to a user who inquiries available rights from the right management server 101a is used. For the contract ID 2304, a contract ID corresponding to the main license 900 is written. In addition to the above mentioned, a validity period of the license which expected by the user (the validity period 915 written in the license header 901 of the main license 900, or the validity period 1015 written in the license header 1001 of the sublicense 1000) may be requested.

Note that, in general, units for processing data which requires security in particular in the terminal apparatus 102, specifically, the license processing unit 2104, the license DB 2105, the content use control unit 2106, the content decryption unit 2107, the content use unit 2108, the viewing record recording unit 2109, and the viewing record DB 2110 are realized by a system LSI structured for anti-tampered hardware or a program structured for anti-tampered software in order to prevent illegal uses by a malicious user and the like. Furthermore, it is assumed that an ID (terminal ID) for uniquely specifying the terminal apparatus 102 in the content reproduction control system 1 is also stored in an anti-tampered area which is not shown in FIG. 21.

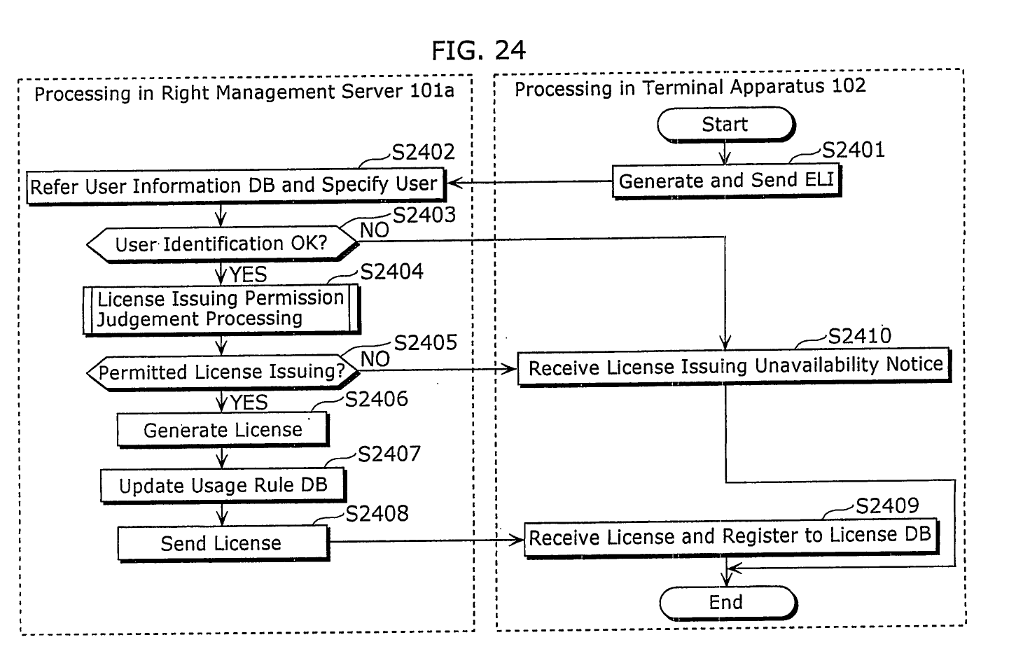

Now, with references to FIG. 24 to FIG. 32, a series of operations in the terminal apparatus 102 configured as above described is explained, the operations, by the user, obtaining the content and the license from the distribution center, securely using the content, and securely controlling the content viewing using the reproduction control information and the record of the viewed content.

Here, when the user obtains the main license 900 from the right management server 101a, it is necessary to previously register for a membership of the service provider using the web server 101d, purchase the usage rules of the content, and the like. However, these processes are not the main purpose of the present invention. Therefore, the explanation is omitted hereafter.

Firstly, an operation of obtaining the main license 900 from the right management server 101a by a user in the terminal apparatus 102 is explained with reference to a flowchart shown in FIG. 24.

FIG. 24 is a flowchart showing processes performed for obtaining the main license 900.

First, the user obtains a list of usage rules (licenses) for the user managed in the right management server 101a through the user interface provided by the terminal application 2111 and selects the license to the contract wished to be obtained from the list of usage rules. The terminal apparatus 102 then generates the ELI 2300 for requesting the main license 900 to the right management server 101a and sends to the right management server 101a (S2401).

In specific, the terminal application 2111 sends thee contract ID corresponding to the contract of the user to the license processing unit 2104. The license processing unit 2104 generates the ELI 2300 shown in FIG. 23 based on the received contract ID. Here, it is suggested that the usage rule ID 2303 to be set in the ELI 2300 has obtained the usage rule ID 2303 by, from the terminal application 2111 or the license processing unit 2104, -directly inquiring to the use management server 101a about the usage rule previously held by the user or by inquiring via the web server 101d. The ELI 2300 generated as above described is sent to the right management server 101a through the terminal communication unit 2102. Note that, the main license 900 may be obtained once during the validity period from the right management server 101a.

The license issuing unit 311 of the right management server 101a receives the ELI 2300 that the server communication unit 312 has received from the terminal apparatus 102, refers to the user information DB 302, and identifies the user by specifying the user (S2402).

Specifically, the user identification is performed in two steps. In general, it is usual that the communication is performed securely by establishing a SAC for communicating data which requires security such as license. Therefore, in the first step, a SAC is established by SSL or TLS between the right management server 101a and the terminal apparatus 102. Through this mutual identification, the right management server 101a can make sure that the terminal apparatus 102 has a correct terminal ID 2302. In the second step, the license issuing unit 311 specifies a user who has the terminal apparatus 102 with the terminal ID 2302. Then, the license issuing unit 311 obtains the terminal ID 2302 included in the ELI 2300, refers to the user ID 601 and the terminal ID 602 in the user information management table 600 of the user information DB 302, and searches the terminal ID 602 in the user information management table 600 corresponding to the terminal ID 2302 included in the ELI 2300. When the corresponding terminal ID 602 is found, a related user ID 602 can be obtained. On the contrary, when the corresponding terminal ID 602 is not found, it is the failure of the user identification.

The license issuing unit 311 verifies the result of user identification in the step S2402 (S2403).

In the step S2403, in the case of NO, that is, when the user identification is not correctly performed, it is judged that the license issuing is not permitted. Thus, the license issuing unit 311 sends a license issuing unavailability notice to the terminal apparatus 102.

In the step S2403, in the case of YES, that is, when the user identification is correctly performed, the step S2404 is executed for verifying the usage rule for issuing the main license 900.

The license issuing unit 311 executes a license issuing permission judgement processing (S2404).

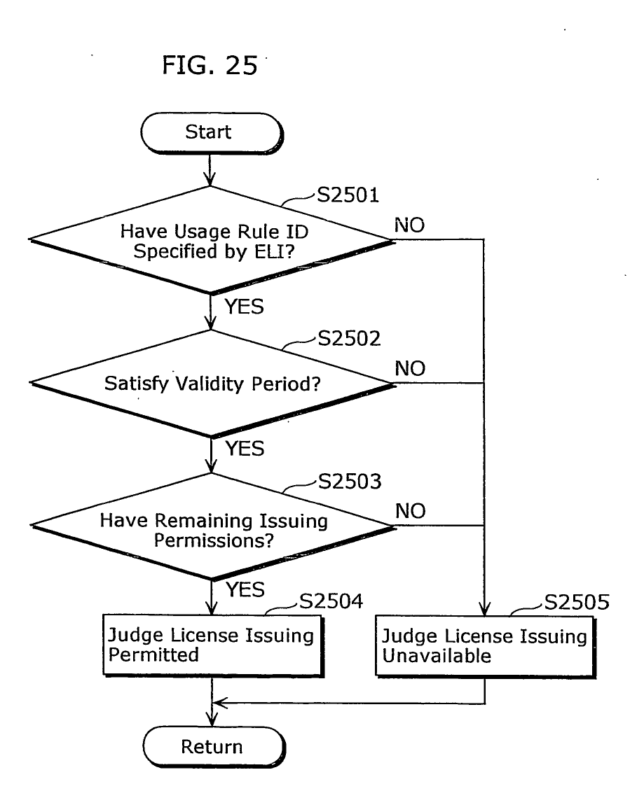

FIG. 25 is a flowchart showing a subroutine of the license issuing permission judgement processing in the step S2404.

First, the license issuing unit 311 verifies whether the usage rule ID 2203 specified by the ELI 2300 is found in the usage rule management table 700 of the usage rule DB 303 (S2501). Specifically, the license issuing unit 311 refers the received ELI 2300 from the terminal apparatus 102 and obtains the usage rule ID 2203. Then, it verifies whether the usage rule ID 2203 matches to the user ID 702 in the usage rule management table 700.

In the step S2501, in the case of YES, that is, when the usage rule ID 2203 of the ELI 2300 and the matching usage rule ID 702 are found in the usage rule management table 900, it is verified about whether the user ID 701 having the usage rule ID 702 matches to the user ID 601 in the use information management table 600 of the user information DB 302 which succeeded to verify in the step S2402 shown in FIG. 24.

When the user ID is matched (YES at S2501), the license issuing unit 311 then judges whether or not the usage rule of the user satisfies the validity period (S2502). Specifically, while referring to the validity period 704 in the usage rule DB 303, the license issuing unit 311 obtains present time from the secure timer unit (not shown in FIG. 3) and judges whether present time is included in the start time and date to the end time and data shown by the validity period 704 For example, when the validity period 704 in the usage rule table 700 is “2002/12/20:12:12:12” and the present time is “2002/12/18 12:34:56”, it is judged that the usage rule of the user is in the validity period. On the other hand, when it is the 2002/12/31 19:00:00”, it is judged that the usage rule of the user is out of the validity period.

In step S2502, in the case of YES, that is, when the usage rule of the user is in the validity period, the license issuing unit 311 judges whether the number of issuing permitted times is remained (S2503). Specifically, the license issuing unit 311 verifies wether the remaining number of issuing availability 705 in the usage rule management table 700 is one or more.

In the step S2503, in the case of YES, for example, if the remaining number of issuing availabilities in the usage rule management table 700 is “2”, the remaining number of issuing availability 705 is one or more so that the license issuing unit 311 judges that the main license 900 can be issued (S252) and returns to the main routine shown in FIG. 24.

On the contrary, in the step S2501 to step S2503, as a result of applying to any one of the following cases, in the case of NO, that is, in the step S2501, when the usage rule ID 2203 of the ELI 2300 and the matching usage rule ID 702 are not found in the usage rule management table 700; in the step S2502, when the usage rule of the user is out of the validity period; in step S2503, when the remaining number of available issuing is 0, the license is suing unit 311 judges that the main license 900 is not permitted for issuing (S2505) and returns to the main routine shown in FIG. 24.

After the license issuing permission judgement processing, the license issuing unit 311 refers to the result of the license issuing permission processing and judges whether or not the main license 900 is permitted for issuing (S2405).

In step S2405, in the case of NO, that is, when it is judged. that the license issuing is not permitted, the license issuing unit 311 sends a license transmission unavailability notice to the terminal apparatus 102.

In step S2405, in the case of YES, that is, when it is judged that the license issuing is permitted, the license issuing unit 311 generates the main license 900 (S2406). Specifically, the license issuing unit 311 refers to the usage rule management table 700 of the ELI 2300 and the usage rule DB303, obtains the work key Kw203 corresponding to the contract ID 2204 (contract ID 401) from the work key management table 400 of the key information DB 301, and generates the main license 900 requested from the ELI 2300.

The license issuing unit 311 updates the usage rule management table 700 of the usage rule DB 303 (S2407). Specifically, the license issuing unit 311 performs processing of subtracting usage rules of the user as much as the usage rules included in the issued main license 900. For example, in the usage rule management table 700, when the main license 900 for the usage rule with the usage rule ID 702 of “URUs-ID-24024” and the user ID 701 of “USER-ID-00003” is requested for issuing, since the remaining number of issuing availability 705 is “2”, the remaining number of issuing availability 705 in the usage rule management table 700 is updated to “1”.

The license issuing unit 311 sends the main license 900 generated in the step S2406 to the terminal apparatus 102 (S2408). Specifically, the license issuing unit 311 sends the main license 900 to the terminal apparatus 102 through the server communication unit 312.

The license processing unit 2104 of the terminal apparatus 102 receives the main license 900 received from the right management server 101a and registers the main license 900 to the license DB 2105 (S2409). Specifically, the license processing unit 2104, through the terminal communication unit 2101, obtains the main license 900 as a response to the ELI 2300 generated in the step S2401, writes the main license 900 to the license DB 2105, updates the hash value of the license DB 2105 and terminates the main processing.

Note that, in Step S2403 or in Step S2405, when the license issuing unavailability notice is sent since the main license 900 is not permitted for issuing, the license processing unit 2104 of the terminal apparatus 102 receives the license issuing unavailability notice (S2410). Specifically, the license processing unit 2104 of the terminal apparatus 102 receives the license issuing unavailability notice from the right management server 101a, through the user interface of the terminal application 2111, notifies the reception to the user and terminates the main processing.

Next, it is explained about a generation processing of the sublicense 1000 and a transmission processing of the-work key Kw203, the content key Kc205, and the sublicense 1000 to the content distribution server 101b.

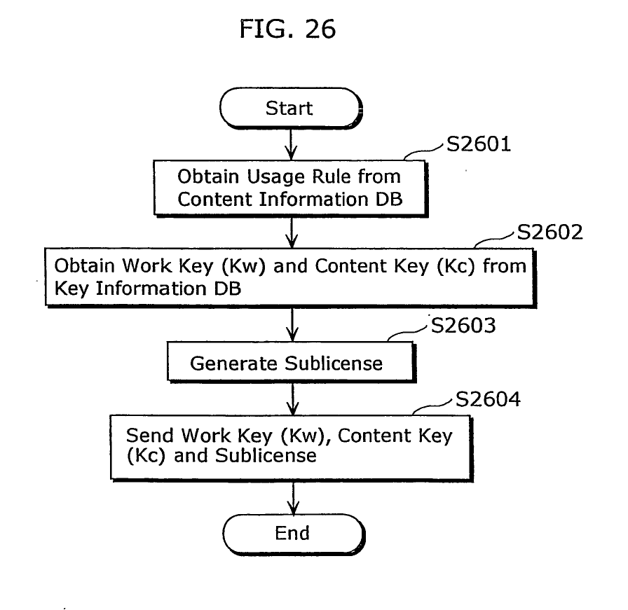

FIG. 26 is a flowchart showing a processing of generating the sublicense 1000 and a processing of sending the work key Kw203, the content key Kc205, and the sublicense 1000 in the right management server 101a.

When the right management server 101a receives, at a request receiving unit not shown in FIG. 3 though the LAN 101n, a request of the work key Kw203, the content key Kc205 and the sublicense 1000 from the content distribution server 101b, the license issuing unit 311, from the content information DB 304 of the database unit 300, obtains information relating to the corresponding content (S2601). Specifically, the license issuing unit 311, based on the content ID included in the request from the content distribution server 10b, obtains the license ID 802, the validity period 803, the number of use availability 804 as usage rules required for generating the sublicense 1000 from the content information management table 800 of the content information DB 304.

The license issuing unit 311, from the key information DB 301 of the database unit 300, obtains the work key Kw203 according to the contract and the content key Kc205 for the content (S2602). Specifically, the license issuing unit 311, based on the contract ID and the content ID included in the request from the content distribution server 101b, obtains the work key Kw203 corresponding to the contract ID 401 and the content ID 501 and the content key Kc205 from the work key management table 400 of the key information DB 301 and the content key management table 500. Note that, whereas it is not shown in FIG. 26 when the contract ID 401 and the content ID 501 corresponding to the request from the content distribution server 101b are not found in the work key management table 400 and the content key management table 500, as an error, it is notified to the content distribution server 101b.

The license issuing unit 311 generates the sublicense 1000 (S2603). Specifically, the license issuing unit 311 generates the sublicense shown in FIG. 10 using the usage rules of the content obtained from the content information management table 800 of the content information DB 304 and the content key Kc205 for the content obtained from the content key management table 500 of the key information DB 301.

The license issuing unit 311 sends the generated sublicense 1000, the work key Kw203, and the content key Kc265 to the content distribution server 101b (S2604). Specifically, the license issuing unit 311 sends the sublicense 1000 generated in the step S2603, the work key Kw203 obtained from the work key management table 400 of the key information DB 301, and the content key Kc205 obtained from the content key management table 500 of the key information DB 301 to the content distribution server 101b through the LAN 101n.

Next, it is explained about the ECM generation processing and the content transmission processing.

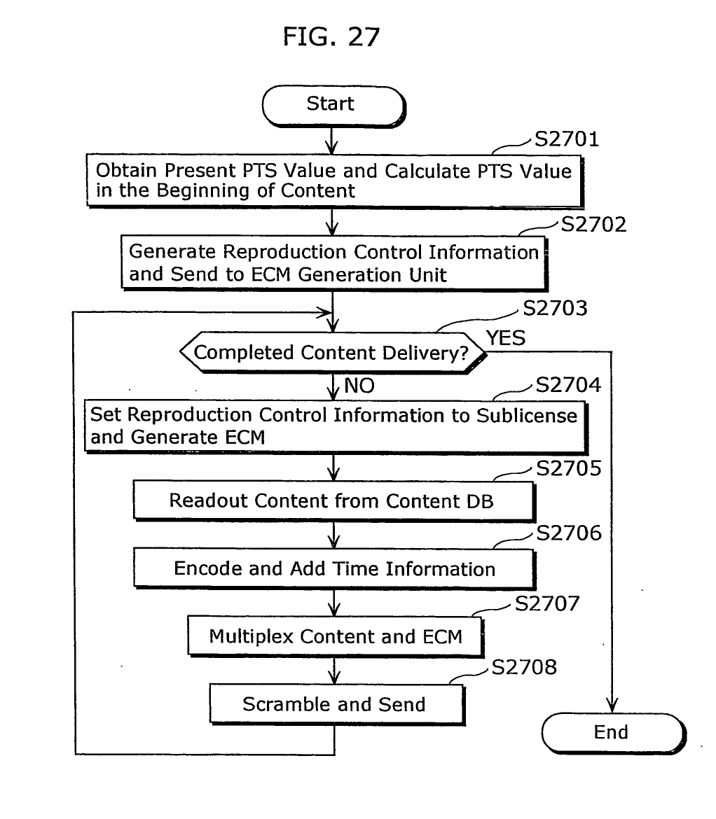

FIG. 27 is a flowchart showing the ECM generation processing and the content sending proceeding of the content distribution server 101b.

In the content distribution server 101b, the reproduction control information generation unit 1106 obtains the present PTS 1343a from the content encoding unit 1105 according to the content delivery instruction and calculates a value of the PTS 1343a in the beginning of the content (S2701). Specifically, the reproduction control information generation unit 1106 receives the content transmission instruction from the upper system not shown in FIG. 11 such as the program operation management system and obtains the value of the PTS 1343a at this time, that is, the value of the STC set by the time information attachment unit 1104. Thus, using the obtained value of the PTS 1343a (time t0 in FIG. 16), by the method explained shown in FIG. 16, the value of the PTS1343a in the beginning of the content (time t2 in FIG. 16) is calculated and stored inside.

The reproduction control information generation unit 1106 generates the reproduction control information based on the information of the content attribute information DB 1102 and transmits to the ECM generation unit 1107 (S2702). Specifically, the reproduction control information generation unit 1106 i) refers the content attribute information management table 1200 of the content attribute DB 1102, ii) obtains the preview permitted section 1203 and the CM section 1204 of the content ID 1201, and iii) generates the reproduction control information for controlling preview and the reproduction control information for controlling CM skip when it is necessary. Herein, using the value of the PTS 1343a calculated in the step S2701 in the beginning of the content, the description of the time information in the content attribute information management table 1200 is changed to the description using the PTS 1343a.

The content delivery unit 1010 judges whether the content delivery is completed or not (S2703). Specifically, the content delivery unit 1110 judges whether or not all of the contents are delivered as TS packet 1400 to the terminal apparatus 102.

In the Step S2703, in the case of NO, that is, when the content delivery is not completed, the step S2704 is executed.

The ECM generation unit 1107 generates and encrypts the ECM using reproduction control information received from the reproduction control information generation unit 1106, the sublicense 1000 received from the right management server 101a, the work key Kw203, and the content key Kc205, and transmits the generated ECM to the content multiplex unit 1108 (S2704). Specifically, the ECM generation unit 1107 i) obtains information required for generating the ECM such as the provider ID 1801 and the content related information 1806 shown in FIG. 18 from the database (not shown in FIG. 11) and the like, ii) generates the ECM-Kw1800 and the ECM-Kc1810 in plaintext, iii) encrypts with the corresponding work key Kw203 and the content key Kc 205 received from the right management server 101a, and iv) generates the encrypted ECM-Kw1800 and the ECM-Kc1810. Furthermore, the ECM generation unit 1107 sets the reproduction control information (control information 1503) obtained from the reproduction control information generation unit 1106 to the sublicense 1006 received from the right management server 101a and generates the Kc distribution ECM 1900 using the provider ID 1901 in plaintext and the like. The Kc distribution ECM 1900 in plaintext is encrypted with the work key Kw203 and the encrypted Kc distribution ECM 1900 is generated. The generated ECM-Kw1800, the ECM-Kc1810 and the Kc distribution ECM 1900 are TS packetted and sent to the content multiplex unit 1108.

Furthermore, the ECM generation unit 1107 sends the scramble key Ks201 which generated inside the ECM generation unit 1107 and updated every few seconds sequential to the content encryption unit 1109 together with the PID of the TS packet 1460 to be encrypted.

The content encoding unit 1105 reads out the content of the content ID from the content DB 1101 (S2705). Specifically, the content encoding unit 1105 searches the content DB 1101 receiving the content ID from the upper system (not shown in FIG. 11) and reads out the contents sequentially.

The content encoding unit 1105 encodes the content readout from the content DB 1101, generates the PES packet 1300 and the TS packet 1400 sequentially, and attaches time information (S2706). Specifically, the content encoding unit 1105 sequentially encodes to MPEG, video and audio of the content read from the content DB 1101 in the step S2705, and using the STC obtained from the time information attachment unit 1104, attaches the PTS1343a and DTS1343b for realizing to synchronize the video ES and the audio ES. Further, whereas the content coding unit 1105 TS packets the PES packet 1300, using the STC obtained from the time information attachment unit 1104, attaches the PCR 1425a for synchronizing base clock inside the terminal apparatus 102 with the base clock (timer unit 1103) of the content distribution server 101b.

The content multiplex unit 1108 multiplexes the content, the ECM and the like and transmits to the content encryption unit 1109 (S2707). Specifically, the content multiplex unit 1108 generates a transport stream in which the information relating to the content is multiplexed, by multiplexing the TS packet 1400 of the content obtained from the content encoding unit 1105 with the TS packet 1400 of the ECM-Kw1800, the ECM-Kc1810 and Kc distribution ECM 1900 obtained from the ECM generation unit 1107. Herein the content multiplex unit 1108 also generates other TS packets 1400 such as PSI (PAT, PMT etc) and other TS packets 1400 such as null packet and multiplexes together with the TS packets 1400 of the content and the ECM. Further, the PCR 1425a is amended when it is necessary. The transport stream generated as described above is sent to the content encryption unit 1109.

After scrambling the transport stream in the content encryption unit 1109, the transport stream is sent from the content delivery unit 1110 (S2708). Specifically, the content encryption unit 1109 scrambles the transport stream received from the content multiplex unit 1108 using the PID such as video and audio received from the ECM generation unit 1107 and with the scramble key Ks201 which sequentially obtains the payload of the TS packet 1400 (TSP Payload 1430) from the ECM generation unit 1107.

Furthermore, the content delivery unit 1110 sends the encrypted TS packet 1400 received from the content encryption unit 1109 sequentially to the terminal apparatus 102. After that, it executes step S2703.

In step S2703, in the case of YES, that is, when the delivery of all contents are completed, the content delivery unit 1110 notifies about that to the content encoding unit 1105, the reproduction control information generation unit 1106, the upper system or the like and terminates the main processing.

Next, an operation of storing and viewing the content in the terminal apparatus 102 is explained.

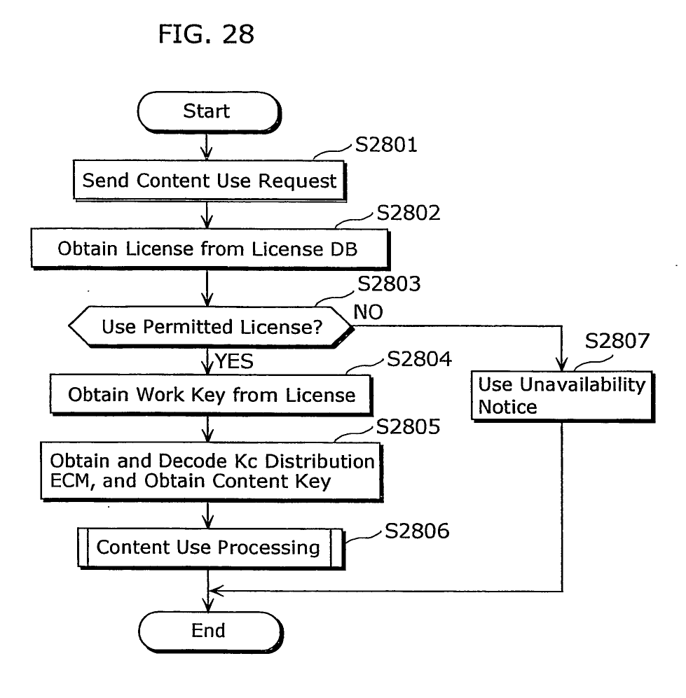

FIG. 28 is a flowchart showing operational processes that the user views, in the terminal apparatus 102, the content stored in the content storage unit 2103.

First, the user selects content wished to be used from the content list through the terminal application 2111. Then, the license ID corresponding to the content notified to the content use control unit 2106 is sent to the license processing unit 2104 (S2801). Specifically, the content use control unit 2106 receives a Unified Resource Identifier (URI) indicating a location of the content ID and the content selected by the user from the terminal application 2111 and obtains the license ID for the content ID using meta data relating to the content included in the terminal apparatus 102. Herein, when the content ID is the subscription content and associated with any contract ID, the license ID corresponding to the contract ID is obtained. Accordingly, the content use is requested by sending the obtained license ID to the license processing unit 2104.

The license processing unit 2104 obtains a license corresponding to the license ID from the license DB 2105 (S2802). Specifically, the license processing unit 2104 receives the license ID from the content use control unit 2106 and searches the license DB 2105.

The license processing unit 2104 obtains the license searched in the step S2802 and judges whether or not the license can be used (S2803). Specifically, the license processing unit 2104 firstly verifies whether the license having the license ID specified from the content use control unit 2106 is found in the license DB 2105. When the license is found, the license processing unit 2104 refers to the validity period of the license and the like and verifies the validity of the license. Here, the validity of the validity period is verified using time information obtained from the secure timer unit 2112 inside the terminal apparatus 102. When the license corresponding to the license ID specified by the content use control unit 2106 is not found in the license DB 2106, the step S2807 is executed.

In step S2803, in the case of YES, that is, when it is judged that the license can be used, the step S2804 is executed.

In step S2803, in the case of NO, that is, when it is judged that the license cannot be used, the step S2807 is executed.

The license processing unit 2104 obtains the main license 900 and obtains the work key Kw203 (S2804). Specifically, the license processing unit 2104 obtains the work key Kw203 set in the encryption key tag block 903 in the main license 900 and stores the obtained work key Kw203 inside.

The license processing unit 2104 obtains the sublicense 1000 included in the Kc distribution ECM 1900, obtains the content key Kc205 and the reproduction control information, and sends to the content use control unit 2106 (S2805). Specifically, the license processing unit 2104 obtains the Kc distribution ECM 1900 separated in the separation unit 2102 and decrypts the encrypted Kc distribution ECM 1900 with the work key Kw203 obtained from the main license 900. When it obtains the sublicense 1000 included in the Kc distribution ECM 1900, it then obtains the content key Kc205 included in the encryption key tag block 1003 of the sublicense 1000 after verifying the validity of the sublicense 1000 by a similar method for the validity judgement for the main license 900 shown in step S2803. Also, it obtains the reproduction control information (control information 1503) included in the control information tag block 1500. The license processing unit 2104 sends the content key Kc205 and the reproduction control information obtained as described above to the content use control unit 2106 by establishing a SAC when it is necessary. Here, the content key Kc205 obtains the scramble key Ks201 for the content so that it is sent to the content decryption unit 2107.

The content decryption unit 2107 and the content use unit 2108 securely use the content based on the content key Kc205 and the reproduction control information obtained by the content use control unit 2106 (S2806).

Note that, in the step S2803, when the usable license is not found, the content use control unit 2106 receives a use unavailability notice from the license processing unit 2104 (S2807). The content use control unit 2106 notifies about the reception to the user through the user- interface unit provided by the terminal application 2111.

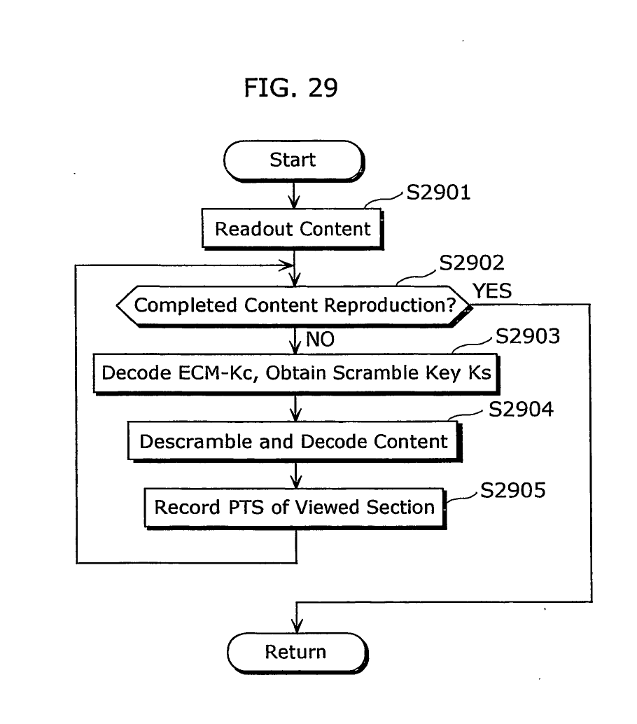

Here, a content use processing in step S2806 is explained using FIG. 29.

FIG. 29 is a flowchart showing a subroutine of the content use processing (S2806).

The content use control unit 2106 instructs the terminal communication unit 2101 to receive content and receives the content from the content distribution server 101b (S2901). In specific, the content use control unit 2106 receives the content sent. from the content distribution server 101b based on the URI (corresponding to a channel for the digital broadcasting) of the content received from the terminal application 2111.

The content use control unit 2106 judges whether or not the content reproduction is completed (S2902). In specific, the content use control unit 2106 judges whether the reproduction of the content is completed when the content reproduction end instruction is sent from the terminal application 2111, when the content reception is completed or not from the content distribution server 101b or by detecting a break of the content using PSI/SI and the like.

In step S2902, in the case of YES, that is, when a notice of the content reproduction end is received from the user through the terminal application 2111 or when the content reception is completed, the content use control unit 2106 notifies about that to the user through the terminal application 2111, returns to the main routine and terminates the main processing.

In step S2902, in the case of NO, that is, when the reproduction of the content is not completed, the content use control unit 2106 executes step S2904.

The content decryption unit 2107 obtains a TS packet 1400 of the ECM-Kc1810 and obtains the scramble key Ks201 (S2903). In specific, the content decryption unit 2107 reconstructs the ECM-Kc1810 from the TS packet 1400 of the ECM-Kc1810 received from the separation unit 2102, using the content key Kc205, decrypts the encrypted ECM-Kc1810, obtains the scramble key Ks201 and stores it into the internal register and the like.

The content decryption unit 2107 obtains the TS packet 1400 of the content, descrambles the TS packet 1400 using the scramble key Ks201 stored in the internal register, and decrypts the reconstructed content (S2904). In specific, the content decryption unit 2107, with reference to transport_scrambling_control included in the TSP Header 1410, descrambles, using the scramble key Ks201, the TS packet 1400 whose payload (TSP Payload 1430) has been encrypted and sends sequentially the descrambled TS packet 1400 to the content use unit 2108. The content use unit 2108 receives the decrypted TS packet 1400 from the content decryption unit 2107, obtains the decrypted PES packet 1300 from the payload (TSP Payload 1430) of the TS packet 1400 and data such as video ES and audio ES of the content, decrypts each ES, and outputs to a monitor (not shown in FIG. 21) while synchronizing the video and the audio. Herein, the content use unit 2108 obtains a PCR 1425a of the Adaptation Field 1420 in the TS packet 1400, and performs a processing of keeping the STC included inside the content use unit 2108 as a stable clock using PLL (not shown in FIG. 15). Therefore, a normal content reproduction is realized by decoding and displaying the video ES, the audio ES and the like of the PES Packet Data Bytes 1360 when the PTS1343a and DTS 1343b of the PES packet 1300 corresponds to each other.

The viewing record recording unit 2109 obtains the PTS 1343a of the content displayed by the content use unit 2108 and records it to -the viewing record DB 2110 (S2905). In specific, the viewing record recording unit 2109 obtains a value of the PTS 1343a (PTS 1343a included in the displayed PES packet 1300) at the point where the content use control unit 2108 reproduces the content, and at least records, into the viewing record DB 2110, values of the PTS 1343a at which the content reproduction is started and ended as viewing records. Note that in order to reduce the data base processing loads on the viewing record DB 2110, for the recording of the PTS 1343a, the value of the displayed PTS 1343a is, whenever necessary, recorded and updated, and the viewing record DB 2110 may be updated at a relevant timing. Also, by recording the PTS 1343a together with date information securely obtained from the timer unit 2112, “play” which is an action instructed by a user, a user ID and a terminal ID of which performed the reproduction, the UL 2200 shown in FIG. 22 is generated and stored into the viewing record DB 2110.

Note that, an operation by the terminal apparatus 102 during the real time viewing differs from the operation shown in FIG. 28 in that, in step 52805 explained in FIG. 28, the scramble key Ks201 is obtained by obtaining the work key Kw203 instead of the content key Kc205 and decoding the ECM-Kw1800 using the work key Kw203. Other steps are same as shown in FIG. 28 and FIG. 29. Therefore, the explanation is omitted in here.

Next, it is explained about an operation of time skipping of the content during the stored content is viewed shown in FIG. 28 and FIG. 29.

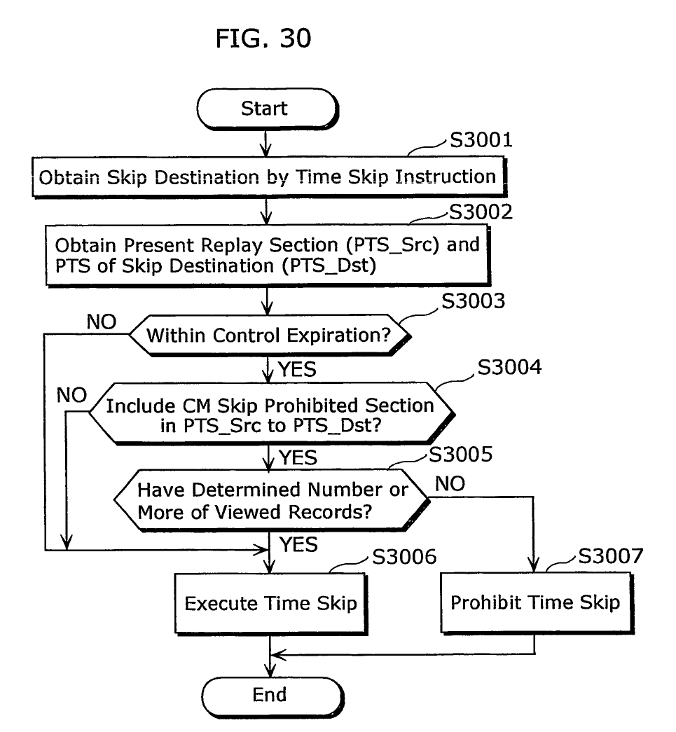

FIG. 30 is a flowchart showing processing operations in the case where the content is time skipped during the stored content is viewed.

When a user requests a time skip of the content on reproduction via the terminal application 2111, the content use control unit 2106 obtains a location of a destination of the skip (S3001). Specifically, the content use control unit 2106 obtains time information (few seconds from where the content is reproduced now etc.) about the skip destination specified by the user.

The content use control unit 2106 obtains the PTS 1343a of the present reproduction place (hereafter referred to as PTS Src) and the PTS 1343a of the skip destination (hereafter referred to as PTS_Dst) (S3002). In specific, the content use control unit 2106 obtains, from the content use unit 2108, the PTS 1343a at which the content is now reproduced (PTS 1343a attached to the frame recently displayed) and converts the time information for the skip destination obtained in Step S3001 into a value based on the PTS 1343a. For example, when the time information obtained in step S3001 is few seconds from where the content is now reproduced, a value of the PTS_Dst which is the PTS1343a for the skip destination is obtained by adding a value which the time information is divided by 90000 which is a clock of the PTS 1343a to the PTS_Src. Here, as an example of a method for the content use control unit 2106 to obtain the value for the PTS_Src, a method of writing, whenever necessary, the value of the PTS 1343a at which the content is now reproduced into the internal register of the content use unit 2108 which his accessible from outside is explained.

The content use control unit 2106 judges whether or not it is in a period of controlling the time skip (special reproduction) based on the reproduction control information obtained from the license processing unit 2104 (S3003). In specific, the content use control unit 2106 judges whether it is now the period when the special reproduction should be controlled by comparing the time information obtained from the secure timer unit 2112 with the value of the control limit 1512 when the control ID 1511 of the reproduction control information (control information 1503) includes information indicating “special reproduction unavailable”.

In step S3003, in the case of YES, that is, when it is now in the period of which the special reproduction should be controlled, the content use control unit executes step S3004.

In step S3003, in the case of NO, that is, when it is not now in the period of which the special reproduction should be controlled, the content use control unit executes steps S3006.

The content use control unit 2106 judges whether or not it is a section where time skip (special reproduction) can be performed based on the reproduction control information obtained from the license processing unit 2104 (S3004). Specifically, the content use control unit 2106, when the control ID 1511 of the reproduction control information (control information 1503) includes information indicating “special reproduction unavailable”, checks whether a section of time from the control start time to the control end time which is a range of the PTS 1343a specified by the control range 1514 is included in the PTS_Src to the PTS_Dst or not for as many as the number of time information control times 1520. That is, it detects a case where a section indicated by a place where the content is now reproduced and a place for the skip destination is included at least a part or all of one CM skip prohibited section (from control start time to control end time of the control information 1503).

In step S3004, in the case of YES, that is, when a CM skip prohibited section is included in the PTS_Src to PTS_Dst, the content use control unit 2106 executes Step S3005.

In step S3004, in the case of NO, that is, when the CM skip prohibited section is not included in the PTS_Src to PTS_Dst, it executes Step S3006.

The content use control unit 2106 obtains the viewing record of the content and judges whether or not the number of time when viewered the part where the CM skip prohibited section included in the PTS_Src to PTS_Dst in the past is the specified number of times or more (S3005). Specifically, the content use control unit 2106 retrieves the viewing record DB 2110 and refers the time information 2210 which is a viewing record of the UL 2200 corresponding to the content ID 2205 among UL 2200 stored in the viewing record DB 2110. Since the value of PTS 1343a which the content is viewed in the past, the content use control unit 2106 counts the number of times including the CM skip prohibited section included in the PTS_Src to PTS_Dst and compares it with the number of control times of controlling the control information 1503

In step 3005, when the number of times when viewed the CM skip prohibited section in the past included in the PTS_Src to PTS_Dst is 1513 or more, the content use control unit 2106 executes step S3006.

In step S3005, when the number of times when viewed the CM skip prohibited section in the past included in the PTS_Src to PTS_Dst is less than the number of control times 1513, the content use control unit 2106 executes step S3007.

The content use control unit 2106 executes the time skip (S3006). In specific, the content use control unit 2106 controls the content decryption unit 2107 and the content use unit 2108 in order to obtain the TS packet 1400 for the specified skip destination from the content storage unit 2103. The operations after the processing is same as the operations explained in FIG. 29.

The content use control unit 2106 prohibits a time skip operation (S3007). In specific, the content use control unit 2106 notifies a user about that the time skip operation is unavailable (together with the reason if necessary) through the user interface of the terminal application 2111.

Whereas an example of time skipping is shown in here, it can prevent a special reproduction on a specified area such as CM of the content by performing similar controls for the cases of other special reproductions (e.g. a fast-forward and rewind of the content).

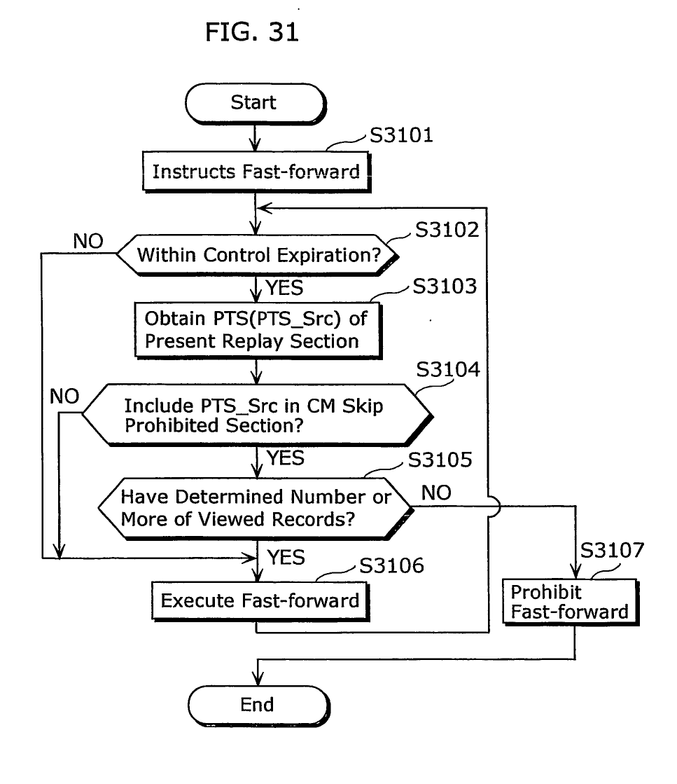

FIG. 31 is a flowchart showing operations in the case where the content is fast-forwarded while the stored content shown in FIG. 28 and FIG. 29 is viewed.

In FIG. 31, when the user requests a fast-forward of the content on reproduction via the terminal application 2111, the content use control unit 2106 receives an instruction for the fast-forward (S3101). Specifically, the content use control unit 2106 receives an action ID indicating a fast-forward from the terminal application 2111.

The content use control unit 2106 judges whether or not it is in the period of controlling the fast-forward (special reproduction) based on the reproduction control information obtained from the license processing unit 2104 (S3102). Specifically, the content use control unit 2106, when the reproduction control information (control information 1503) includes information indicating that its control ID 1511 is “special reproduction unavailable”, judges whether it is now in the period when the special reproduction should be controlled by comparing the time information obtained from the secure timer unit 2112 with the value of the control limit 1512.

In step S3102, in the case of YES, that is, when it is now in the period of which the special reproduction should be controlled, the content use control unit 2106 executes step S3103.

In step S3102, in the case of NO, that is, when it is not now the time of which the special reproduction should be controlled, the content use control unit 2106 executes step S3106.

The content use control unit 2106 obtains the PTS 1343a of the present part where the content is reproduced (hereafter referred to as PTS Src) (S3103). In specific, the content use control unit 2106 obtains the PTS 1343a for the part where the content is now reproduced (PTS 1343a attached to the frame displayed recently) from the content use unit 2108.

The content use control unit 2106 judges whether or not it is a part where the fast-forward (special reproduction) can be performed based on the reproduction control information obtained from the license processing unit 2104 (S3104). Specifically, the content use control unit 2106, when the reproduction control information (control information 1503) includes information indicating the control ID 1511 is “special reproduction unavailable”, at the time from the control start time to the control end time which is a range of the PTS 1343a specified by the control range 1514, checks whether the PTS_Src is included or not for as many as the number of time information control times 1520. That is, it detects a case where the part where the content is now reproduced is included in at least one of the CM skip prohibited section (the control start time to the control end time of the control information 1503).

In Step S3104, in the case of YES, that is, when PTS_Src is included in the CM skip prohibited section, the content use control unit 2106 executes step S3105.

In Step S3104, in the case of NO, that is, when PTS_Src is not included in the CM skip prohibited section, it executes step S3106.

The content use control unit 2106 obtains the viewing record of the content and judges whether the number of viewing the CM skip prohibited section including the PTS_Src in the past is a specified number or more (S3105). Specifically, the content use control unit 2106 retrieves the viewing record DB 2110 and refers the time information 2210 which is viewing record of the UL 2200 matching the content ID 2205. Since the time information 2210 indicates a value of the PTS 1343a that the content is viewed in the past, the content use control unit 2106 counts the number of records which the CM skip prohibited section including the PTS_Src is viewed and compares it with the number of control 1513 of the control information 1503.

In step S3105, when the number of times when the CM skip prohibited section including the PTS_Src is viewed in the past is the number of control times 1513 or more, the content use control unit 2106 executes step S3106.

In step S3105, when the number of times when the CM skip prohibited including the PTS_Src is included is viewed in the past is less than the number of control times 1513, it executes step S3107.

The content use control unit 2106 executes a fast-forward (S3106). Specifically, the content use control unit 2106 controls the content decryption unit 2107 and the content use unit 2108 in order to obtain the TS packet 1400 corresponding to a speed of the fast-forward from the content storage unit 2103. Generally, it is likely that an I picture of MPEG is only displayed in the case of fast-forward . . . Therefore, the content use control unit 2106 selects the TS packet 1400 for only the I picture while referring to information in the TSP Header 1410 in the TS packet 1400 and information in the Adaptation Field 1420. After the skipping, it takes same operations as explained in FIG. 29. In order to judge whether a reproduction part which changes along with the fast-forward is the CM skip prohibited section or not whenever necessary, it repeatedly executes processes of step S3102 to step S3106. Note that, when repeatedly executing the processes of steps S3102 to step S3106, if necessary, the process of step S3105 can be omitted. In this case, the process in step S3105 is processed as NO and the content use control unit 2106 executes step S3107.

The content use control unit 2106 prohibits an operation of fast-forward (S3107). Specifically, it notifies a user through the user interface of the terminal application 2111 of that the fast forward operation is not permitted (together with the reasons if necessary).

Thus, it can control the special reproduction, of a specific section of the content, during the limited time and for the limited number of times. Whereas it explains a case of fast-forward in here, the CM rewind can be similarly controlled.

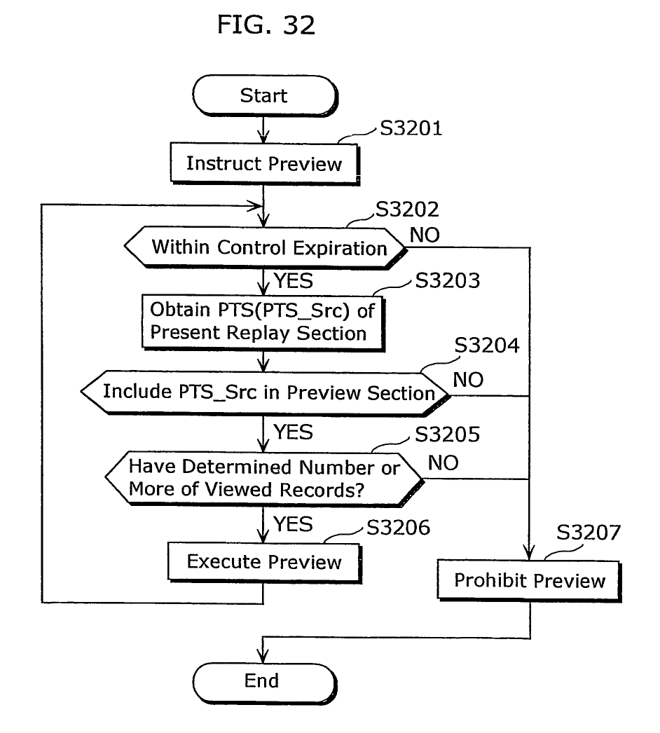

Further, whereas the control method described in the embodiment of the present invention is not limited for the case of the special reproduction, it can be used for the purpose of controlling the viewing of the special section of the content. As an example for this case, an operation of controlling to view a preview section of the PPV content with reference to FIG. 32.

FIG. 32 is, similar to FIG. 30 and FIG. 31, a flowchart showing operations of previewing the content while content is being viewed.

When a user requests to reproduce a preview of the content via the terminal application 2111, the content use control unit 2106 receives a preview instruction (S3201). Specifically, the content use control unit 2106 receives an action ID showing a preview from the terminal application 2111.

The content use control unit 2106 judges whether it is now within a period of controlling the preview based on the reproduction control information obtained from the license processing unit 2104 (S3202). Specifically, the content use control unit 2106, when the reproduction control information (control information 1503) includes information that the control ID 1511 is “preview permitted”, judges whether it is now in a period when the preview can be executed by comparing date information obtained from the secure timer unit 2112 with the value of the control limit 1512.

In step S3202, in the case of YES, that is, when it is now in a period of which the preview can be executed, the content use control unit 2106 executes step S3203.

In step S3202, in the case of NO, that is, when it is not now in the period of which the preview can be executed, it executes step S3207.

The content use control unit 2106 obtains the PTS 1343a for a section where the content is now being reproduced (hereafter referred to as PTS_Src) (S3203). Specifically, the content use control unit 2106 obtains the PTS 1343a for a section where the content is now being reproduced from the content use unit 2108 (PTS 1343a attached to the frame displayed recently).

The content use control unit 2106 judges whether or not it is a section where the preview is allowed based on the reproduction control information obtained from the license processing unit 2104 (S3204). Specifically, the content use control unit 2106, when the reproduction control information (control information 1503) includes information indicating the control ID 1511 is “preview permitted”, checks whether or not the PTS_Src is included, for as many as the number of time information control times 1520, in a time range of the control start time to the control end time which is a range of the PTS 1343a specified by the control range 1514. That is, it detects a case where the section where is now being reproduced is included at least one preview permitted section (from the control start time to the control end time of the control information 1503).

In step S3204, in the case of YES, that is, when the PTS_Src is included in the preview permitted section, the content use control unit 2106 executes step S3205.

In step S3204, in the case of NO, that is, when the PTS_Src is not included in the preview permitted section, the content use control unit 2106 executes step S3207.

The content use control unit 2106 obtains the record of viewing the content and judges whether the number of viewing the preview permitted section including the PTS_Src in the past is the specified number and more (S3205). Specifically, the content use control unit 2106 retrieves the viewing record DB 2110 and refers time information 2210 which is viewing record of the UL 2200 corresponding to the content ID 2205 among the UL 2206 stored in the viewing record DB 2110. Since the time information 2210 indicates the value of the PTS 1343a that the content is viewed in the past, the content use control unit 2106 counts the number of records which the preview permitted section including the. PTS_Src is included is viewed and compares it with the number of control 1513 of the control information 1503.

In step S3205, when the number of times when the preview permitted section including the PTS_Src is viewed in the past is the number of times 1513 and more, the content use control unit 2106 executes step S3207.

In step S3205, when the number of times when the preview permitted section including the PTS_Src is viewed in the past is less than the number of control times 1513, it executes step S3206.

The content use control unit 2106 executes previewing (S3206). Specifically, the content use control unit 2106 permits a preview of the content, and decrypts and decodes the content. Further, since the reproduction section is changed along with the preview, processes of step S3202 to step S3206 are repeatedly executed in order to judge, whenever necessary, whether or not the section where the content is now being reproduced is preview permitted or not. Note that, when repeatedly executing the processes of step S3202 to step S3206, if necessary, a process of step S3205 can be omitted. In this case, the process of the step S3205 is all processed as YES and the step S3206 is executed.

The content use control unit 2106 prohibits previewing (S3207). Specifically, the content use control unit 2106 notifies a user of that the preview is not permitted (with its reason if necessary) through a user interface of the terminal application 2111.

Thus, as for previewing the PPV content, the content use control unit 2106 can control the preview in a limited time period and the limited number of times.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

As above described, in the content reproduction control system 1, the distribution center 101, using previously existed secure time information which attached to the content, distributes, to the terminal apparatus, the reproduction control information for controlling the use of a specific part of the content as another data from the content. The terminal apparatus securely controls the use of content using secure time information previously existed in the content and reproduction control information obtained from the distribution center 101. Therefore, the provider can use a pre-existed encoder so that the cost relating to the transmission equipment can be reduced and the provider can securely control the use of specific part of the content by a user.

Note that, in the embodiment according to the present invention, an example in the case where the PTS 1443a of the PES packet is used as time information attached to the content is shown. However, the present invention is not limited to the case and information previously existed in the content and can be specified its part of the content can be used, the information being such as the DTS 1443b of PES packet, the PCR 1425a of TS packet 1400, Sync Layer (SL) of MPEG-4 Systems, Time Code of Group of Picture of MEPG-2 ES. In this case, when the time information which is not encrypted such as the PCR 1425a of the TS packet 1400 is used, a process for securely distributing the content with the time information is needed in order to prevent the alternation of the time information, the process of associating a value of time information with the encryption key of the content, attaching a hash value to the data including the value of the time information and the like.

In addition, an example of the content multiplexed by the MPEG-2 PES/TS is shown in the embodiment according to the present invention. However, it is needless to say that contents other than MPEG-2 Program Stream (PS) or MPEG are applicable unless the content is pre-existed information and information which can specify its part of the content (for example, it is not limited to the time information if it is at least an ID, a counter value or the like unique to each packet in the content).

Also, in the present embodiment according to the present invention, an example of distributing the content based on the server type broadcasting method type I described in ARIB STD-B25 version 4.1 is shown. However, it is needless to say that the present invention is applicable to the case of the server type broadcasting method type II which is a distribution method for file-type contents, a streaming distribution on the Internet, a download distribution and the like. In this case, the content is generally encrypted with a single encryption key Kc′ so that an encryption key Kc′ is set to a license (equivalent to the main license 900 in the embodiment of the present invention) and distributes the license from the right management server 101a to the terminal apparatus 102 via communication such as Internet. Similarly, the reproduction control information is included in the license. Accordingly, the content is not scrambled by a contingency key, even when it is encrypted with a single encryption key (that is, when it has a single license structure rather than a license structure of the main license 900 and the sublicense 100), the use of specified part of the content can be securely controlled in the terminal apparatus 102.

Further, in the present embodiment according to the present invention, in the UL 2200 which is a viewing record, various information starting from the user ID 2103 and the terminal ID 2104 are recorded. However, in order to use for the content use control based on the viewing record, the content and the viewing section of the content shall be specified. Therefore, a pair of the content ID 2105 or the license ID 2106, or the content ID 2105 and the license ID 2106 (depending on a way of assigning ID in the content reproduction control system 1), and a pair of one or more start time information and end time information shall be recorded.

Further, in the embodiment according to the present invention, an example of the case where the viewing record recorded in the terminal apparatus 102 is managed in the viewing record DB 2110 is shown. However, it may be managed in the license DB 2105 together with the license to be managed (main license 900).

Additionally, in the embodiment according to the present invention, as an example of controlling use of the specific section of the content, an example of performing CM skip is shown. However, not limiting to the example, for example, it is applicable to a control for using only the specific section of the content such as digest viewing.

Also, in the embodiment according to the present invention, as information of reproduction control sections in the reproduction control information (control information 1545), a value of the PTS 1343a attached to the content itself is used and specified. However, the control information 1545 may be structured using a value of the PTS 1343a in the beginning of the content and a relative value from the beginning of the content based on the PTS 1343a. Additionally, whereas in the control information 1545, the reproduction control section is described in a range specified by the control start time and the control end time, it may be described as control start time and control time (time range).

Furthermore, in the embodiment according to the present invention, as information for the reproduction control section in the reproduction control information (control information 1545), a special reproduction prohibited section (section where only allows normal reproduction) is described. However, the special reproduction permission section may be described in the control information 1545.

Further, in the embodiment according to the present invention, it is shown an example of the case where the reproduction control information is set to the license (sublicense 1000) and the ECM and is distributed from the distribution center 101 to the terminal apparatus 102. Not being limited to the case, the reproduction control information may be distributed using a secure channel such as SSL through communication or by EMM through broadcasting. Therefore, the present method is a method integrally applicable to contents despite the multiplex of related information such as ECM. Note that, in such case when the terminal apparatus 102 has not obtained reproduction control information (control information 1545) at the time when the content is used, for viewing the content, it may be controlled to allow only the normal reproduction or not to permit a preview and allow the special reproduction, preview or the like after the reproduction control information is obtained.

In the case where the control information 1545 is structured using a value of the PTS 1343a in the beginning of the content and the relative value from the beginning of the content based on the PTS 1343a, a reproduction control section is specified by the relative value from the beginning of the content based on the PTS 1343a when the content distribution server 101b may delivers the streaming contents and distributes the PTS 1343a from the content distribution server 101b to the terminal apparatus 102 after the PTS 1343a in the beginning of the content is specified. Herein, while the terminal apparatus 102 has not obtained the PTS 1343a in the beginning of the content, it is controlled to allow only the normal reproduction or not to permit the preview.

In the embodiment according to the present invention, a license (sublicense 1000) is set to the Kc distribution ECM 1900 and transmitted from the distribution center 101 to the terminal apparatus 102. However, the present invention is not limited to the above example, the license may be distributed by the ECM-Kw1800, the ECM-Kc1810, or the EMM (including the Kc distribution specific EMM in the server type broadcasting method type I). Also, in a distribution by broadcasting, using the ECM-Kw1800 or the ECM-Kc1810 (if necessary, EMM for distributing the work key Kw203 may be used), a license including the content key Kc205 and reproduction control information may be distributed via communication.

Further in the embodiment according to the present invention, as an example of control information for controlling the use of specific section of the content, an example of distributing information for reproduction control (reproduction control information) is explained. However, the present invention is applicable for use controls in the terminal apparatus 102 such as printing and editing other than reproducing.

Also, whereas, in the embodiment according to the present invention, the reproduction control information is generated in the content distribution server 101b, it may be generated in the right management server 101a. In this case, it is needless to say that information of the PTS 1343a attached to the content needs to be notified from the content distribution server 101b to the right management server 101a. Furthermore, in the content distribution server 101b, the reproduction control information is set to the sublicense 1000. However, it may be set in the right management server 101a.

In the embodiment according to the present invention, an example of recording viewing records for all used contents in the terminal apparatus 102 is explained. However, whether recording the viewing records by each content, license, or user may be controlled by including information instructing a recording of the viewing records into the main license 900 or the sublicense 1000.

Further, in the embodiment according to the present invention, it is explained as an example that the reproduction control information generation unit 1106 in the content distribution server 101b obtains a value of the PTS 1343a from the content encoding unit 1105 for generating reproduction control information. However, the value of STC used by the content coding unit 1105 may be obtained directly from the time information attachment unit 1104. Note that, in this case, the value of STC used by the content encoding unit 1105 and the value of STC used by the reproduction control information generation unit 1106 need to be equal.

Also, in the embodiment according to the present invention, it is explained as an example that, when the reproduction control information generation unit 1106 in the content distribution server 101b streams content (real time encode), the value of PTS 1343a in the beginning of the content is calculated in order to generate the reproduction control information. However, when it downloads content (pre-encode), the value of PTS 1343a in the beginning of the content and values of CM section, preview permitted section and the like can be previously specified so that, based on the value of PTS 1343a actually attached to the content, the reproduction control information can be generated.

In the present embodiment according to the present invention, as a control ID 1511 of the reproduction control information (control information 1503), an example of using IDs called “special reproduction unavailable” and “preview permitted” is explained. However, the present invention is not limited to the example unless it is an identifier for defining a user's operation and a processing of content in the terminal apparatus 102.

Furthermore, in the embodiment according to the present invention, it is explained as an example that limitations such as the number of times viewed in the past based on the viewing records and the control time limit by an absolute time are added to the control ID 1511. Additionally, limitations such as viewing time in the past may be added.

In the embodiment of the present invention, it is explained as an example that a reproduction of a specific section of the content is controlled using the viewing records stored in the viewing record DB 2110. However, based on the viewing records, the reproduction control information (control information 1545) may be changed. For example, when a special reproduction prohibited section is viewed for predetermined number of times or more, information about the special reproduction prohibited section is deleted from the control information 1545. Accordingly, the reproduction control based on the viewing records can be performed even after the viewing records are sent to the distribution center 101 and the like.

Also, in the embodiment of the present invention, it is explained as an example that the reproduction control information is set to the Kc distribution ECM 1900. However, it may be set to the ECM-Kw1800 or the ECM-Kc1810. At this time, if different control information is set respectively to the ECM-Kw1800 and the Kc distribution ECM 1900, different reproduction control ranges can be realized for the real time viewing and the stored viewing. For example, in the case of the preview, it is inevitable to be an undifferentiated preview section with a stable time from the beginning during the real time viewing. However, it can set a preview range reflecting characteristics of the content such as digest viewing during the stored viewing. Thus, it can provide a service fully reflecting the storage function of the terminal apparatus 102.

Furthermore, in the embodiment according to the present invention, it is explained as an example that a content, a license, control information and the like are obtained from a single distribution channel. However, they can be obtained from a combined distribution channel such as a combined use of the digital broadcasting and the Internet.

### INDUSTRIAL APPLICABILITY

The content reproduction control system according to the present invention has an effect of preventing the use of content with a low cost by a user who is contrary to an intension of a provider by realizing to securely control the use control of a specific part of the content such as a CM section of the content in the terminal apparatus using secure time information existed previously in the content without adding control information to the content. The content reproduction control system is useful as a content reproduction control system and the like for the content distribution service through the digital broadcasting, CATV, the Internet and the like. Also, it is applicable to the content reproduction control system for the content distribution service by a portable media such as a package media.

1. A content reproduction control system comprising a server apparatus and a terminal apparatus that are connected to each other via a communication path,
wherein the server apparatus includes:
a control information generation unit operable to generate, based on time information attached to a content, control information which specifies a range for permitting and prohibiting a user's predetermined operation on the content performed in the terminal apparatus; and
a distribution unit operable to distribute the control information to the terminal apparatus, and
the terminal apparatus includes:
a content use unit operable to use the content;
a receiving unit operable to receive the control information; and
a content use control unit operable to control a reproduction of the content based on the received control information, the reproduction being included in the use of the content performed by the content use unit.

2. The content reproduction control system according to claim 1,
wherein the control information indicates a section where a special reproduction of the content is prohibited.

3. The content reproduction control system according to claim 1,
wherein the control information indicates a section where only a normal reproduction of the content is permitted.

4. The content reproduction control system according to claim 1,
wherein the control information indicates a section where a preview of the content is permitted.

5. The content reproduction control system according to claim 1,
wherein the time information is a value of the time information attached to the content.

6. The content reproduction control system according to claim 5,
wherein the time information is composed, based on at least one of a Program Clock Reference of a Transport Stream, a Presentation Time Stamp of a Packetized Elementary Stream, and a Decoding Time Stamp of the Packetized Elementary Stream.

7. The content reproduction control system according to claim 1,
wherein the time information is composed of time information about a beginning of the content and time information about an offset from the beginning of the content.

8. The content reproduction control system according to claim 7,
wherein the time information is composed based on at least one of a Program Clock Reference of a Transport Stream, a Presentation Time Stamp of a Packetized Elementary Stream, and a Decoding Time Stamp of the Packetized Elementary Stream.

9. The content reproduction control system according to claim
wherein the receiving unit receives the control information by broadcasting from the server apparatus.

10. The content reproduction control system according to claim 9,
wherein the control information is issued for a user's contract and assigned to either a main license indicating a license which allows use of a plurality of contents under the contract or a sublicense indicating a license issued for a single content.

11. The content reproduction control system according to claim 1,
wherein the receiving unit receives the control information through communication with the server apparatus.

12. The content reproduction control system according to claim 9,
wherein the control information is issued for a user's contract and assigned to either a main license indicating a license which allows use of a plurality of contents under the contract or a sublicense indicating a license issued for a single content.

13. The content reproduction control system according to claim 1,
wherein the control information includes a type of the permitted operation.

14. The content reproduction control system according to claim 1,
wherein the control information includes at least one of, for until a specific operation is permitted, a number of viewings, viewing time and a viewing validity period.

15. The content reproduction control system according to claim 14,
wherein the specific operation is one of a commercial message skip, a commercial message fast-forward and a commercial message rewind.

16. The content reproduction control system according to claim 1,
wherein the control information includes a limit concerning a permitted number of operations or permitted time.

17. The content reproduction control system according to claim 16,
wherein the permitted operation is a preview of the content.

18. The content reproduction control system according to claim 1,
wherein the control information is issued for a user's contract and includes a license ID that specifies either a main license indicating a license which allows use of a plurality of contents under the contract or a sublicense indicating a license which is issued for a single content.

19. The content reproduction control system according to claim 1,
wherein the content use control unit controls use of the content so that the predetermined operation cannot be operated when the control information is not yet obtained.

20. The content reproduction control system according to claim 1,
wherein the terminal apparatus further includes
a viewing record recording unit operable to record a viewing record including a viewed portion of the content, and
the content use control unit controls use of the content in the content use unit using the control information and the viewing record.

21. The content reproduction control system according to claim 20,
wherein the content use control unit controls a permission for a special reproduction of the content to permit a special reproduction of the content when an amount of the viewing records exceeds a limit of the amount of the viewing records which can be included in the control information.

22. The content reproduction control system according to claim 1,
wherein the control information generation unit predicts a value of time information and generates the control information when the content is a stream type content.

23. The content reproduction control system according to claim 1,
wherein the control information generation unit generates, when the content is a stream type content, the control information after a delivery of the content is started.

24. The content reproduction control system according to claim 23,
wherein the control information generation unit further generates control information only including a beginning time of a distribution of the content, and
the distribution unit distributes the generated control information after the distribution of the control information which excludes the generated control information.

25. The content reproduction control system according to claim 1,
wherein the control information generation unit generates, when the content is a file type content, the control information using time information after a value is defined.

26. The content reproduction control system according to claim 1,
wherein the control information is assigned at least to one of a content key (Kc) distribution Entitlement Control Message (ECM), an Entitlement Control Message-work key (ECM-Kw) and an Entitlement Control Message-content key (ECM-Kc) for digital broadcasting.

27. The content reproduction control system according to claim 26,
wherein different control information are assigned respectively to the ECM-Kw and the Kc distribution ECM.

28. The content reproduction control system according to claim 26,
wherein different control information are assigned respectively to the ECM-Kw and the ECM-Kc.

29. The content reproduction control system according to claim 1,
wherein a portion of the predetermined operation that is permitted or prohibited is different between two cases: when the content is viewed in a real time; and when the content is stored and viewed.

30. A server apparatus in a content reproduction control system comprising the server apparatus and a terminal apparatus that are connected to each other via a communication path, comprising:
a control information generation unit operable to generate, based on time information attached to the content, control information which specifies a range for permitting or prohibiting a user's predetermined operation on a content in the terminal apparatus; and
a distribution unit operable to distribute the control information to the terminal apparatus.

31. A terminal apparatus in a content reproduction control system comprising a server apparatus and the terminal apparatus that are connected to each other via a communication path, comprising:
a content use unit operable to use a content;
a receiving unit operable to receive control information; and
a content use control unit operable to control a reproduction of the content based on the received control information, the reproduction being included in the use of the content performed by the content use unit,
wherein the control information is information which specifies, based on time information attached to the content, a range for permitting or prohibiting a user's predetermined operation on the content in the terminal apparatus.

32. A content reproduction control method used for a content reproduction control system comprising a server apparatus and a terminal apparatus that are connected to each other via a communication path, the method including steps A executed in the server apparatus and steps B executed in the terminal apparatus,
wherein the steps A include steps of:
generating control information that generates, based on time information attached to the content, control information which specifies a range for permitting or prohibiting a user's predetermined operation on a content in the terminal apparatus; and
distributing the control information to the terminal apparatus,
the steps B include steps of:
using the content; and
controlling a reproduction of the content based on the received control information, the reproduction being included in the use of the content.
